(19) United States
(12) Patent Application Publication
(10) Pub. No.: US 2007/0075136 A1
(43) Pub. Date: Apr. 5, 2007

(54) Hotel inventory management system and method

(75) Inventor: Kurien Jacob, New York, NY (US)

Correspondence Address: Altimatia, L.L.C., 16 Elm Ridge Road, Pennington, NJ, 08534, US

(73) Assignee: Travel Tripper LLC, Englewood, NJ (US)

(21) Appl. No.: 11/235,351

(22) Filed: Sep. 26, 2005

(51) Int. Cl. G06K 15/00

(52) U.S. Cl. 235/383; 705/5

(57) ABSTRACT

A system and method for managing time-dependent inventory such as hotel rooms, rental automobiles, and airline seats as well as associated items is disclosed. The system and method may be used to manage the price of inventory, the type of inventory, and the dates the inventory is offered for sale. The disclosed system and method simplify the management of inventory across multiple inventory types, inventory prices, and inventory availability dates by creating hierarchies and allowing changes to one element of a hierarchy to cause changes to other elements in the hierarchy.

### FIELD

The invention relates to the field of inventory management and distribution, specifically the management of time-dependent inventory such as hotel rooms, airline seats, rental automobiles, and other associated items.

### BACKGROUND

While the description that follows relates to hotel rooms, persons skilled in the art will realize that the problems described and solutions offered apply to rental items and time-dependent inventory generally. The value of time-dependent inventory is a function of time. Yesterday's airline seat, yesterdays rental car, and yesterdays hotel room stay have no value today. Maximizing rental revenue relies on maximizing the use of rental property. One way to insure maximum use of time-dependent inventory is to take advantage of many different sales channels.

Today several sales channels are available to hotels as shown in FIGS. 1, 2 and 3. Rooms may be booked directly through the hotel's reservation staff, through the hotel's web site, through consolidator web sites such as Expedia™ or Travelocity™, through tour operators, through travel agents using global distribution systems such as Sabret™ or Apollo™, through telephone reservation services providers, and through other computerized reservations systems. The wide variety of sales channels has brought great benefits to consumers as well as hotels, however the growth in the number of sales channels has created a sales and inventory management problem.

Property owners and administrators typically manage hotel room sales by defining multiple rate types which cater to the needs of clients. While multiple rate types help the administrator by providing flexibility, they complicate the problem of rate maintenance. Managing multiple rate types across multiple room types over a number of days with constraints can balloon into a tedious, error-prone, and time consuming task. Embodiments of the invention address the complicated task of managing constraints, multiple rate types, across multiple room types, across multiple dates.

Hotel reservation systems have been previously described, for example in U.S. patent application publications 2002/0152100, 2003/0144867, 2004/0249684, and in U.S. Pat. Nos. 5,832,451 and 5,832,454 all of which are hereby incorporated herein by reference. In addition to a system that accepts reservations, administrators require a sales and inventory management system that will allow them to respond quickly to the dynamic nature of the marketplace, pricing and repricing inventory as necessary based upon changes in availability, reservation date, weather, and other factors. The system should allow the administrator to change the pricing of all items based upon class, occupancy, discounts, package deals, preferred client, or any other factor affecting price, with a minimum of data entry by the staff. While current systems support the marketing of package deals, administrators would benefit from a system that would allow consumers to define their own package deals, tailored to their individual preferences. The system should quickly distribute updated pricing information, availability information, and other information to the sales channels, preferably in real time. Such a system would insure that each sales channel would always be working with the most up-to-date pricing, availability, and other information.

### SUMMARY

Embodiments of the present invention are computer program systems comprised of a series of code segments. The code segments may comprise an analysis code segment, a revenue enhancement code segment, a pricing code segment, a portal code segment, a property code segment, a room type code segment, rate type code segment, rate grid code segment, add-on management code segment, engine customization code segment and at least one communications code segment. A schematic diagram of a system of the invention and its connection to sales channels is shown in FIG. 7. The code segments may be implemented in the form of computer software or computer hardware or a combination of computer software and hardware. The code segments comprise a system to manage the sales, pricing, and inventory information related to time-dependent items, such as hotel rooms, rental automobiles, airline seats and associated items.

The system may be configured to communicate with the hotel staff, the hotel property management database, and a plurality of selling channels, for example global distribution systems (GDS's) such as Apollo™ or Sabre™, telephone reservation systems, a hotel web site, consolidator web sites such as Expedia™ or Travelocity™, computerized reservation systems, and tour operators. The system allows hotel users to log into the system, check current room pricing and inventory information, change current pricing and inventory information, and distribute the updated pricing and inventory information to the sales channels. The system also allows the hotel operators to distribute information related to other items for sale, allowing hotel patrons to create a dynamic al-a-carte package deal for themselves.

The system comprises a pricing code segment configured to allow the property administrators to manage room pricing information. The pricing code segment comprises the pricing functions. The prior art pricing change process is illustrated in FIG. 4. A property administrator wishing to change rates for rooms must manage each room type, rate type, date, and constraint type combination individually. As the number of room types, rate types, dates, and constraints grow, the task of changing and/or managing the information grows geometrically. As illustrated in FIG. 5, embodiments of the invention define a matrix of relationships between room types, rate types, and room constraints. The pricing code segment functions by basing room prices upon the price of a standard room offered at the best available rate (BAR). For example, a standard single occupancy room may be offered at a particular BAR. The hotel user then enters the rates of the other rooms as a function of the BAR. Double occupancy may command a rate of BAR plus an extra person charge, triple occupancy may command a rate of BAR plus 2 times the extra person charge. A deluxe room may be priced at 15% above BAR, or $50 above BAR, or some other figure based upon BAR. Prices based upon combinations of room type, occupancy, special discounts, group discounts, and preferred client pricing may be set. Once the matrix of the dependencies upon the BAR are set, the system can calculate the prices of the available rooms. The matrix of BAR dependencies needs only to be set once. Subsequent room pricing changes may be implemented by changing only BAR. The rest of the room prices and rates can be calculated automatically based upon the matrix of BAR dependencies. Individual room prices may be set manually, overriding prices calculated by the matrix of BAR dependencies. Once pricing changes have been implemented the results may be distributed through the communication code segment or code segments to the sales channels. By defining a matrix of relationships or hierarchies between room types, rate types, and constraints, embodiments of the invention allow PA's to modify one rate, for example the BAR rate of a standard room type, and have other rates (floating rates) automatically changed as illustrated in FIG. 6.

In addition to distributing information to the sales channels, the system may contain a code segment configured to accept reservations. The incoming information is used to make reservations, keep the hotel room inventory information up to date, and to allow confirmation of hotel reservations.

The system may further comprise a revenue management code segment. The revenue management code segment is used to analyze the information received from the sales channels, information relating to client, date, length of stay, time of year, weekday vs. weekend, average occupancy and other factors to maximize hotel revenue.

### BRIEF DESCRIPTION OF THE DRAWINGS

FIG. 1 Current booking systems

FIG. 2 Detail of internet merchants

FIG. 3 Detail of internet merchant with intermediaries

FIG. 4 Current rate update process

FIG. 5 Rate hierarchy matrix

FIG. 6 Rate change cascade

FIG. 7 Embodiment of the system of the invention

FIG. 8 Summary of administrative and EU workflow

FIG. 9 Menu selections available to superusers, EAs and PAs

FIG. 10 Home page of a superuser account

FIG. 11 User management form

FIG. 12 User management form showing list of users

FIG. 13 Portal list page displayed to superusers

FIG. 14 New portal addition form

FIG. 15 Portal information editing form

FIG. 16 Property list page accessible to EAs and superusers

FIG. 17 New property addition form

FIG. 18 Property list page accessible to PA

FIG. 19 Form used to enter default property information

FIG. 20 Form used to edit property information

FIG. 21 Form used to edit property information

FIG. 22 Form used to add a tax item to the property information

FIG. 23 Form used to add property information

FIG. 24 Property amenities list

FIG. 25 Form used to add a property amenity

FIG. 26 Property facilities list

FIG. 27 Form used to add a property facility

FIG. 28 Property room type list

FIG. 29 Form used to add a property room type

FIG. 30 Property bed type list

FIG. 31 Form used to add a bed type

FIG. 32 Room amenities list

FIG. 33 Form used to manage room hierarchies

FIG. 34 Property rate type list

FIG. 35 Form used to add a rate type

FIG. 36 Rate grid display, all rate types selected

FIG. 37 Rate grid display, floating rate types selected

FIG. 38 Rate grid display, non-floating rate types selected

FIG. 39 Form for selecting a date range

FIG. 40 Form for managing rates and inventory

FIG. 41 Form for managing rates and inventory

FIG. 42 Form for managing rates and inventory

FIG. 43 Form for managing rates and inventory

FIG. 44 Property Add-on list

FIG. 45 Form for adding an add-on

FIG. 46 Property policy list

FIG. 47 Form for adding a policy

FIG. 48 Booking engine customization form

FIG. 49 Booking engine customization form

FIG. 50 Booking engine customization form

FIG. 51 Booking engine customization form

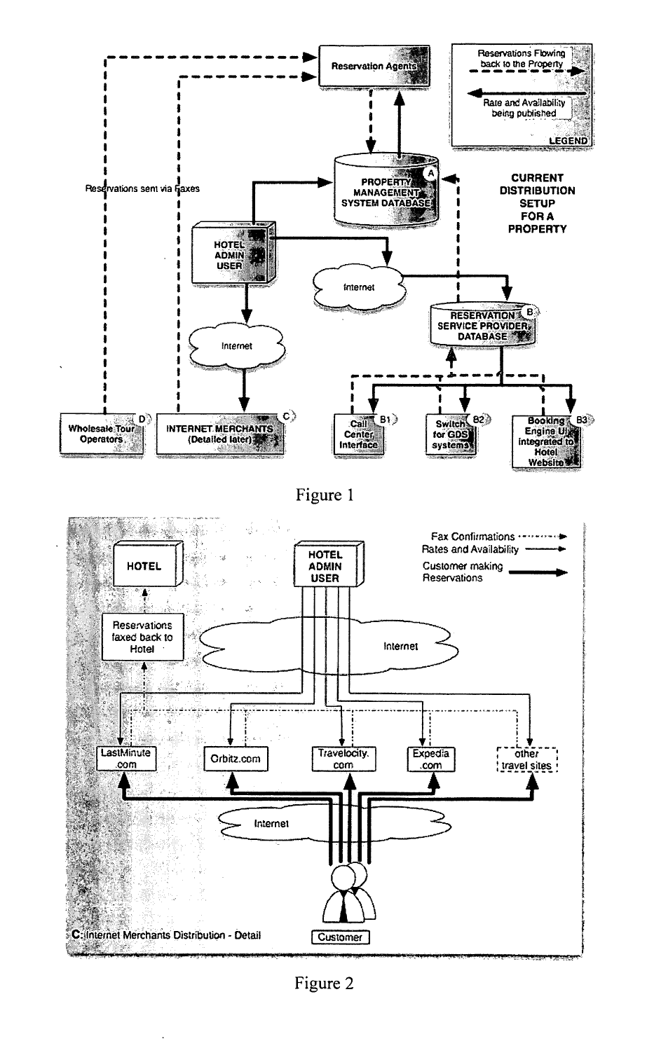

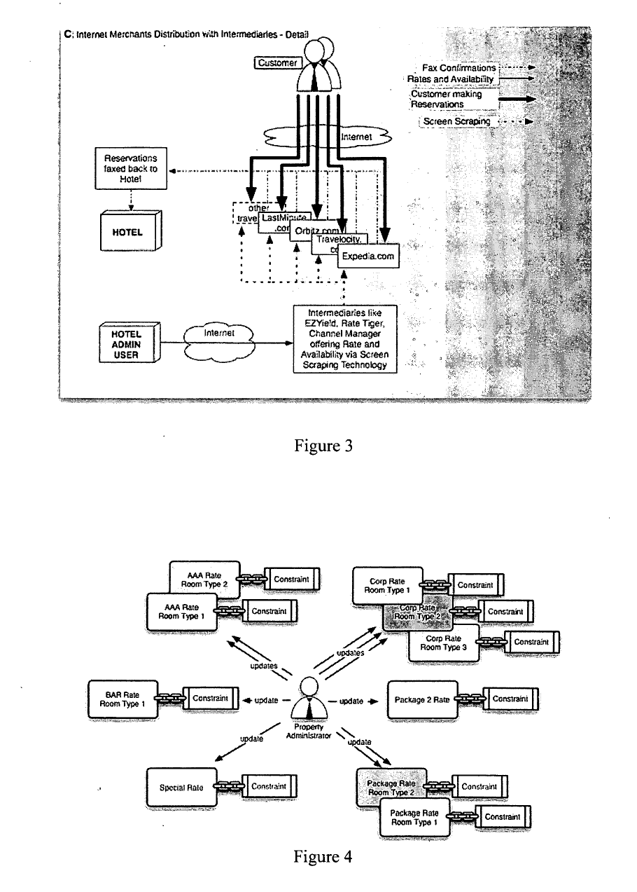

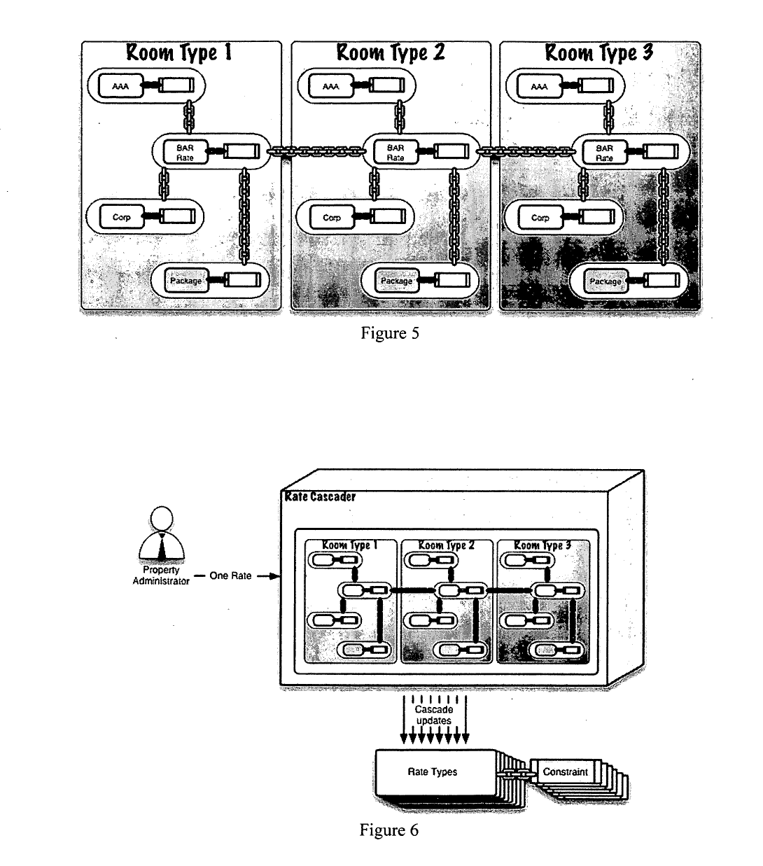

### DETAILED DESCRIPTION

In describing embodiments of the invention the following definitions will be used.

As used herein a GDS, or Global Distribution System, is a term used for major travel reservation systems (such as Apollo™, Sabre™, Worldspan™) which have a worldwide presence and were originally designed to provide reservations for the airline industry. Approximately 500,000 travel agents have access to these systems, which have been extended to allow bookings for the hotel/travel industry. p As used herein End User, or EU refers to the users who come to a Property website, search for rooms, and optionally make a reservation. An EU may be a hotel customer or a travel agent using a GDS, a tour operator, a telephone reservation center worker, or other person using the system to make a reservation.

As used herein Superuser, or SU, refers to the user or group of users that can perform every action in the system across any portal and Property that exist in the system. The SU has complete authority to manage any function available in the system.

As used herein an Engine Administrator, or EA is a user or group of users, similar to the superuser, who can perform every action in the system, but only on properties and users which they have created in the system. An EA cannot view or edit details on properties/users created by other EA's.

As used herein a Property Administrator or PA is a user or group of users who are the owners/employees of properties that are managed with the system. The PA is responsible for configuring and maintaining daily rates, the inventory, and the property features that show up via the reservation engine.

As used herein a Property refers to any hotel, motel, resort or the like that sells its rooms/amenities/packages/items via the system and the reservations engine.

As used herein a Room refers to any room, suite, penthouse, apartment, studio, or other space available for rent at a Property. A room may comprise a bedroom, a bedroom/bathroom combination, a bedroom/sitting room/bathroom combination, a conference room, a ballroom, a dining room, office, or other room or combinations of rooms.

As used herein a Portal refers to a Property or series of Properties managed as an entity. Users of the system may comprise owners of individual properties, owners of multiple properties, and others who may not own properties but instead agree to sell groups of rooms on a contract basis. A direct Portal refers to all the Properties that are directly utilizing the services of the reservation engine. An indirect Portal refers to Properties that have contracted some or all of their rooms to an intermediary, and the intermediary has chosen to use the services of the reservation engine. A single physical

Property can be part of either a direct portal or an indirect portal, or both. A portal is a logical grouping of rooms and/or properties that allows one person to manage groups of Properties/Rooms from a single point.

As used herein the Reservation Engine, Bookings Engine, and RezTrip™ Reservation Application refer to an application used by EU's to make reservations. One embodiment of the invention, RezTrip™, comprises a reservation engine for use by EUs, and an administrative application for use by hotel owners/employees.

As used herein the Reservation Workflow refers to the series of forms, displayed on computer screens, that will be shown to EUs and sales channels, so as to allow them to search for Property rate information, availability information, package information, add-on information, and other information for their chosen dates, and optionally complete a reservation transaction.

As used herein Room Type refers to a class of rooms available at a Property. A Property may be comprised of various room types, such as standard, deluxe, and suite. Room types may be distinguished by amenities, location, size, and color scheme. Many rooms may share characteristics in common and therefore it is convenient to refer to a class of similar rooms by room type.

As used herein Rate Type refers to a class of room rate. The same room may be sold at different rates to different users based upon a variety of conditions (promotion code, booking periods, group rates) on the same date. Examples of rate types might be the AAA® rate, the AARP® rate, the corporate rate, the government rate, and the standard rate. Each rate belongs to a rate type, a logical grouping of rates applied to room types over periods of time.

As used herein the Best Available Rate or BAR is the default rate applied to a room. The BAR, or BAR rate is synonymous with Default Rate or Regular Rate.

As used herein a Floating Rate is a rate that is expressed as a function of the BAR rate. For example if a standard room type is offered at the BAR rate the deluxe room type may be offered at 15% above the BAR rate, or fifty dollars above the BAR rate, or a package deal might be offered at the BAR rate plus seventy five dollars. When a PA changes the BAR rate of the standard room type, the floating rate values are automatically calculated by the system, and optionally communicated to the sales channels.

As used herein a Sales Channel or Selling Channel refers to a wholesale or retail selling channel. Sales channels may comprise GDS system, telephone reservations systems, tour operators, hotel web sites, consolidator web sites such as Expedia™ or Travelocity™.

As used herein a Function or Functions refer to computer algorithms or algorithmic routines which manipulate or process or store or operate upon data and/or interact with users. Code segments which manage data do so through their associated functions.

As used herein an Item refers to an amenity item, add-on item, facility item, or package item that may be sold through the reservation engine along with rooms. Items are typically selected by EU's during the reservation process to allow them to customize their reservation. Item pricing is dynamically calculated based upon factors comprising item price, number of persons using an item, and length of stay.

Although prices are described in Dollars, it is to be understood that the system may use any currency for example, Euros, UK Pounds Sterling, Swiss Francs, French Francs, Indian Rupees and the like.

Although the system and its user interface are shown using the English language, it is to be understood that embodiments of the invention may use any language. For example, embodiments of the invention may use French, German, Dutch, Swedish, Norwegian, Finish, Russian, Spanish, Italian, Japanese, Chinese, Portuguese, Arabic, Turkish, Polish, or other languages.

Embodiments of the invention comprise computer program systems configured to manage the data and perform the methods/functions of the invention. The computer program systems are comprised of code segments, each code segment being configured to perform certain methods and/or functions of the invention. When combined, the code segments form a code segment configured to manage hotel data, and other time-dependent inventory data. Such code segments may comprise a pricing code segment configured to manage pricing data, a portal code segment configured to manage portal data, a property code segment configured to manage property data, a room type code segment configured to manage room type data, a room type hierarchy code segment configured to manage room type hierarchy data, a rate type code segment configured to manage rate type data, a rate grid code segment configured to manage rate grid data, an add-on management code segment configured to manage add-on data, an engine customization code segment configured to manage engine customization, and at least one communications code segment configured to manage communications between the system and a plurality of sales channels. The code segments of embodiments of the invention may be stored on a computer readable medium such as hard disk storage, compact disk storage, digital video disk storage, random access memory, dynamic random access memory, read-only memory, static random access memory, and magnetic tape. Embodiments of the invention may be implemented in computer software, computer hardware or combinations of computer hardware and software. Embodiments of the invention may be located on one computer or on a plurality of computers connected to one another through a wired or wireless network. Embodiments of the invention may use encrypted on non-encrypted communications over wired or wireless networks. Embodiments of the invention comprise a user interaction code segment configured to manage user interaction that delivers output to users, and accepts input from users via an interface utilizing a web browser such as Internet Explorer™, Navigator™, Opera™, Mozilla Firefox™, or other internet web browser. User input may be in the form of mouse clicks, typed text input from a keyboard or other input device, voice input, or stylus input.

Embodiments of the invention are configured to run on general purpose computers. Such computers are typically comprised of a central processing unit, random access memory, hard disk storage, mouse, keyboard, and display. Embodiments of the invention may be configured to run on standard operating systems such as Microsoft Windows™, Unix™, Linux™, or any other computer operating system. Embodiments of the invention may be created using standard programming and scripting languages such as C, C++, Fortran, Pascal, Basic, Perl, Python, Visual Basic, Visual C++, Visual C#, Java, Javascript, VBScript, HTML, DHTML, CSS, and awk.

Embodiments of the invention comprise a computerized database such as Oracle™, SQL Server™, DB2™, MySQL, Microsoft Access™ or other relational or non-relational databases. The database is configured to manage hotel data comprising portal data, property data, room type data, rate type data, room hierarchy data, rate grid data, inventory data, add-on data, package data, policy data, bed type data, pricing data, user data, availability data, date data, amenity data, facility data, constraint data, audit trail data, engine customization data, sales channel data, communications data, and other data. In addition, embodiments of the invention comprise code segments configured to interact with the database, to interact with users (EU's, SU's, EA's, and PA's), and to communicate with other systems, such as sales systems (sales channels) of vendors. Communications may be encrypted or unencrypted and may take place on wired or wireless networks.

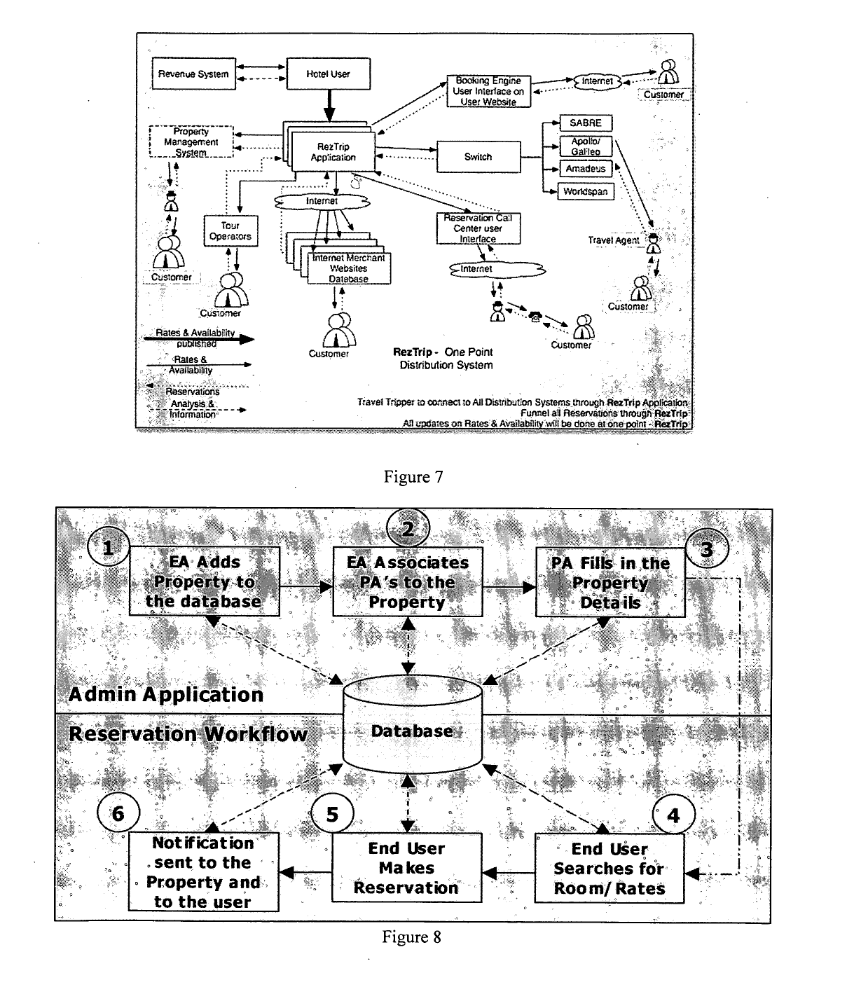

The system RezTrip™ is an exemplary embodiment of the invention and will be described below. As shown in FIG. 7, the RezTrip™ system communicates with the hotel user, the hotel property management system, tour operators, internet web merchants, reservation call centers, GDS systems, and the hotel's own website. It is to be understood that the elements comprising the invention may be embodied in other programs and that the description of the RezTrip™ embodiment is for illustrative purposes only and is not intended to limit the invention to the specific embodiment described.

The basic workflow of the system is shown in FIG. 8. An EA or SU adds a Property to the system. The data relating to the Property are stored in the system database. The EA or SU then associates a PA with the property. The PA administers the Property, initially by entering relevant Property information such as descriptions, room types, room rates, amenities, facilities, and policies, and later by managing inventory and room rates. Once the PA has set up the Property within the system, EUs may connect to the reservation engine, either directly or through intermediaries, select a room, and make a reservation. After an EU has made a reservation, confirmation information is sent to both the EU as well as the Property.

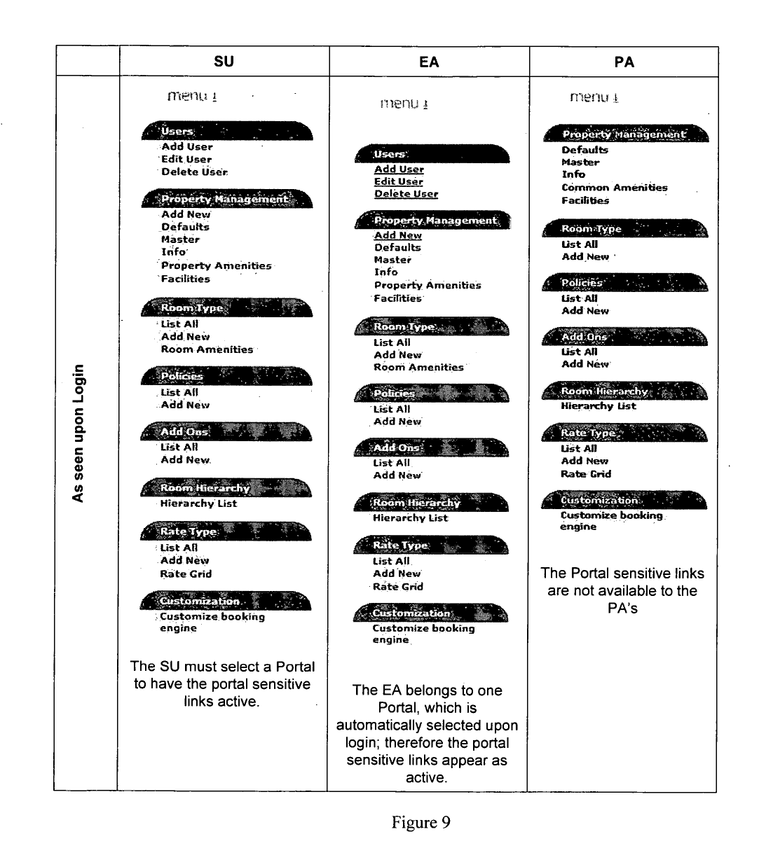

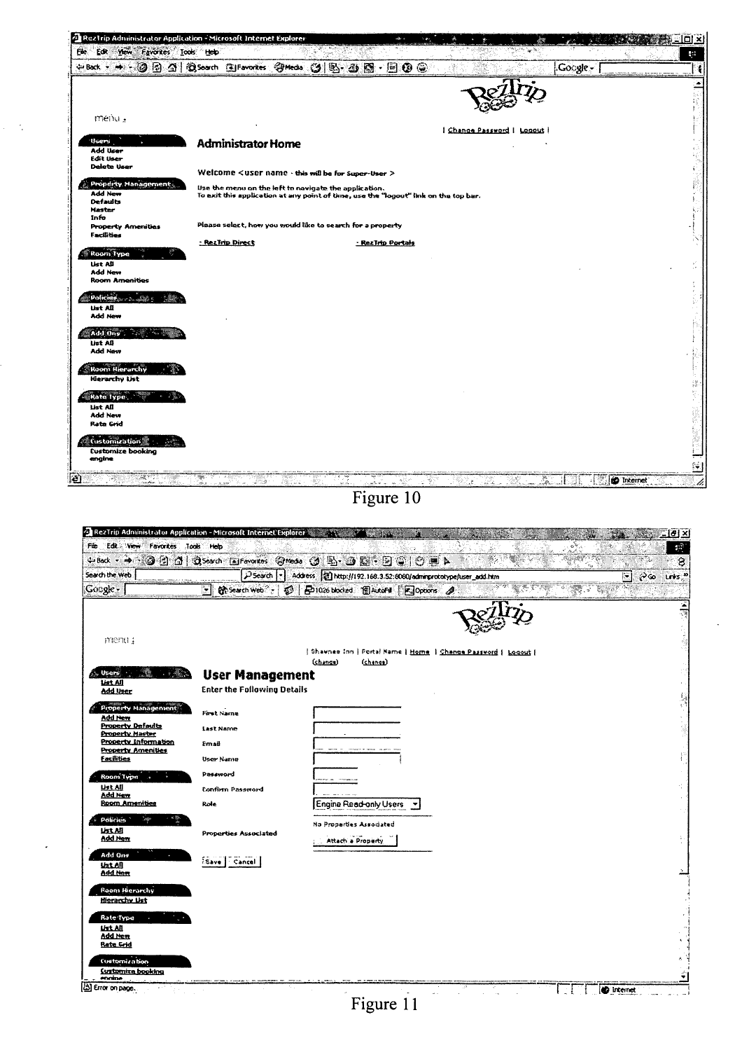

After initial system installation and initial configuration are completed a user may begin to work by logging in to the system. System functions are accessed by clicking on menu items and entering data into forms. Administrative users, including SUs, EAs, and PAs are allowed to log into the system. The users are authenticated and then depending on their authorization level they are connected to the relevant section of the application. The basic commands available to SU, EA, and PA users are shown in FIG. 9. The login screen is similar for all users, but upon login each user is shown a screen tailored to the role the user is expected to perform. An SU login screen is shown in FIG. 10.

Upon login the SU is presented with the option of picking the portal they want to work within as shown in FIG. 13; no other action is possible until a portal has been chosen. After choosing a portal, menu functions become available. While a SU may perform all system and property management functions, properties are generally managed by less privileged EA and PA users.

Each EA is associated with only one portal. Upon login an EA is shown the list of properties that belong to their portal. The EA is able to “Add User”, “Edit User”, “Delete User”, and “Add New Property.” These functions do not require the selection of a specific property within the portal. If the EA selects a Property then the property management functions become accessible. While an EA may manage a property, property management is generally performed by PA's.

A PA is associated with one portal, but each portal may have multiple Properties assigned. Upon login the PA will be shown a list of Properties to choose from. After choosing a Property they will be able to manage the selected Property.

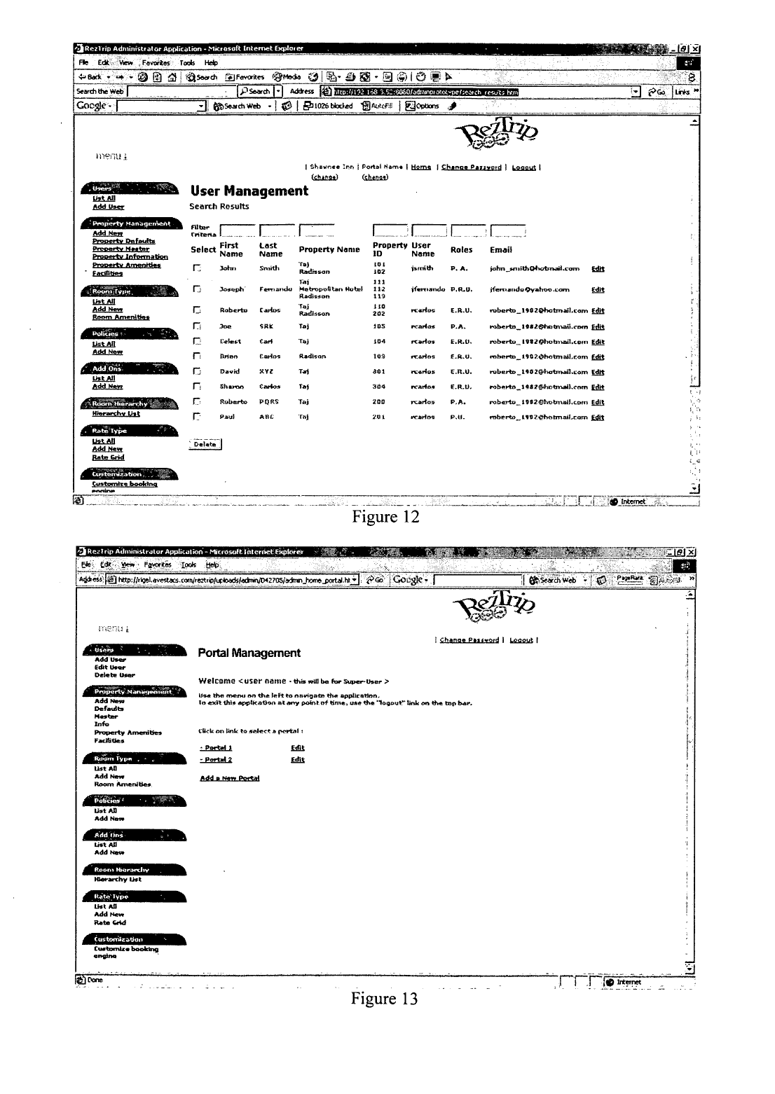

SUs and EAs can manage users. User management comprises the functions “Add New User” (including associating a user with a property) as shown in FIG. 11, “Edit Existing User”, and “Delete User” as shown in FIG. 12.

The portal code segment is configured to manage Portal data and comprises Portal functions. A Portal refers to a Property or series of Properties managed as an entity.

The RezTrip™ application may have clients that comprise:
Individual Properties
A group of Properties
Companies who may not own Properties, but have bought batches of Rooms from other properties to sell to clients.
A management company or chain that owns several properties.

The same physical Property may belong to multiple categories. The application is designed to group instances of Properties into Portals. Each Portal can then have users defined within it to maintain the Property or properties, including inventory, rates and other tasks. By default the system is created with at least one direct Portal. This portal will typically be used to handle individual Properties and their users; however some of groups of Properties and their users may also belong to this Portal.

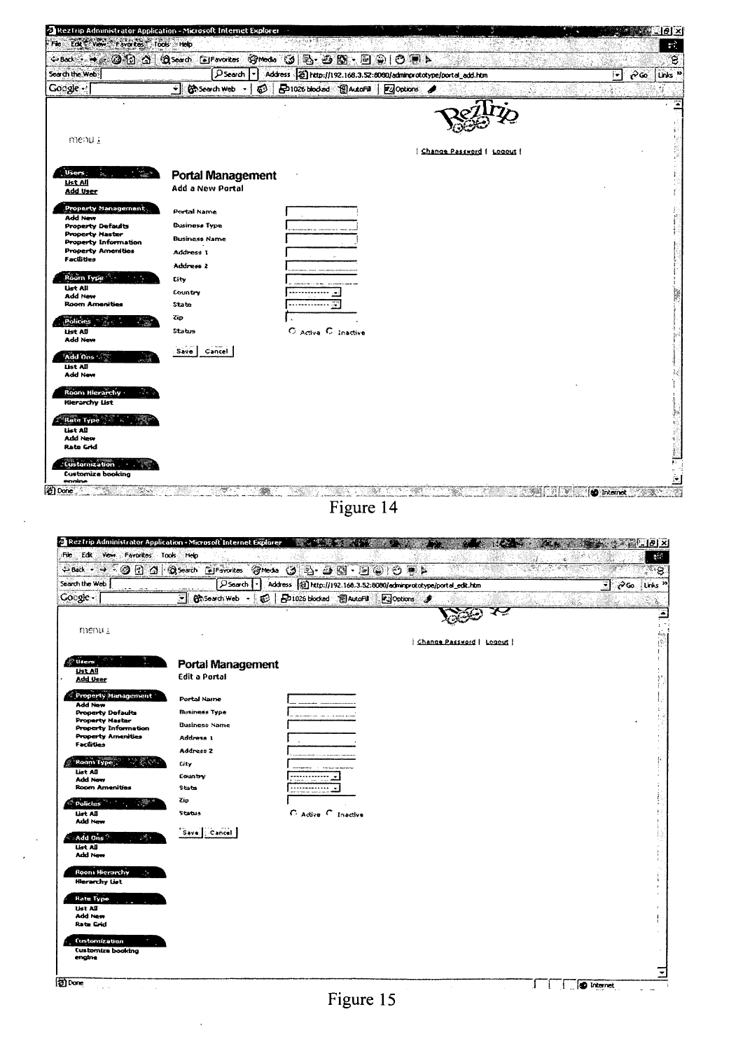

As shown in FIGS. 13, 14, and 15, the system allows SUs to select portals; create new portals, enter portal data, to edit portals, and to activate/inactivate portals. Portals are created, edited, and activated/inactivated by clicking on the appropriate menu items on the relevant screens and entering the required data in the forms. Each portal may have Properties and users created within it. The associations between a Property and users are performed within the scope of a portal. A Property from one portal cannot be associated with an EA or a PA from another portal. EAs operate within the portal with which they are associated. SUs may operate on any portal in the system.

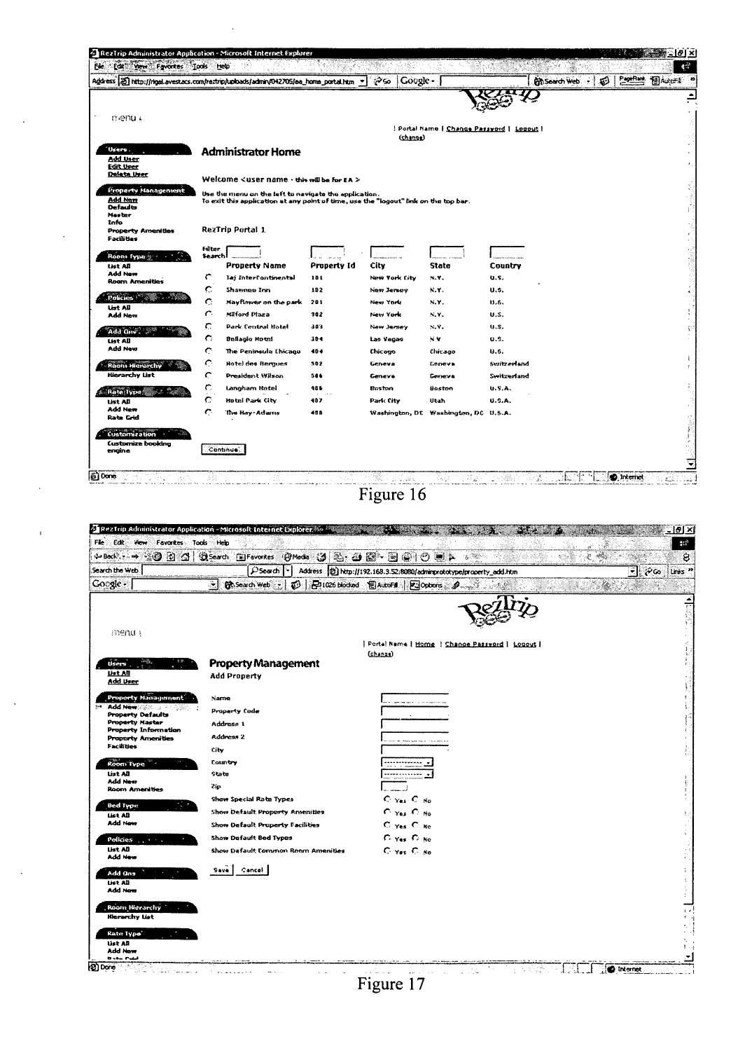

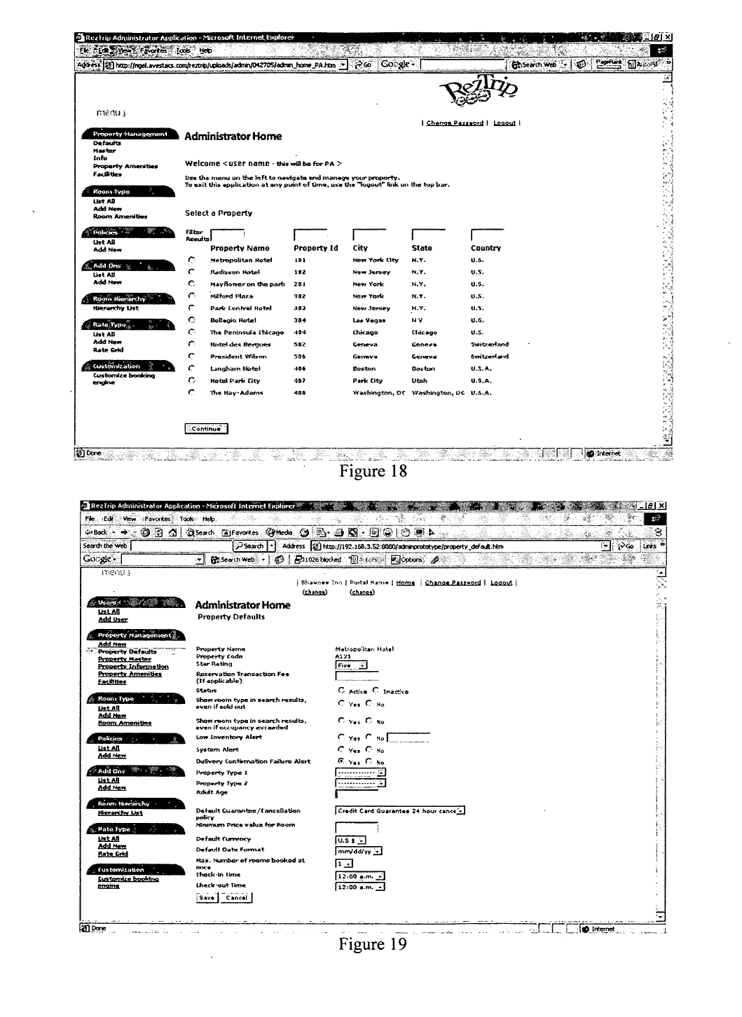

The property code segment is configured to manage property data and comprises property functions. After an SU has logged in and selected a portal, or after an EA has logged in, a list of Properties is displayed as shown in FIG. 16. From this screen an EA or SU may add Properties to the portal as well as perform other Property management tasks. A Property may only be created within a portal. Typically, the SU or EA will add at least one Property to a portal using the form shown in FIG. 17; then the SU or EA will associate at least one new user or existing user with the Property as the PA. The PA's Property list screen is shown in FIG. 18. With the exception of adding a Property, the PA can perform all property administration functions. The PA maintains the Property information and rates on a day to day basis. Once the rate grid has been populated, EU customers are allowed make reservations.

A Property may be made inactive, which is analogous to deleting the Property. An inactive Property will not be accessible for Property management. However, the Property's data are never deleted from the database, since the data are kept for auditing purposes.

To allow EUs to access the system PAs have to enter and manage:
Basic Property information
Amenity information, both Property and Room
Facility information
Room Types
Rate Types
Rate discounts
Daily room inventory

Basic Property information comprises information such as location, number of rooms, telephone number, facsimile number, class of hotel, interior and exterior photographs, and parking information.

During the course of working with a Property all SU, EA, and PA users are clearly shown the portal and the Property to which they are making changes. The administrative users (SU, EA, PA) have the ability to change Properties, to move from one Property to another. If the user is logged on as SU then the user also has the ability to change portals.

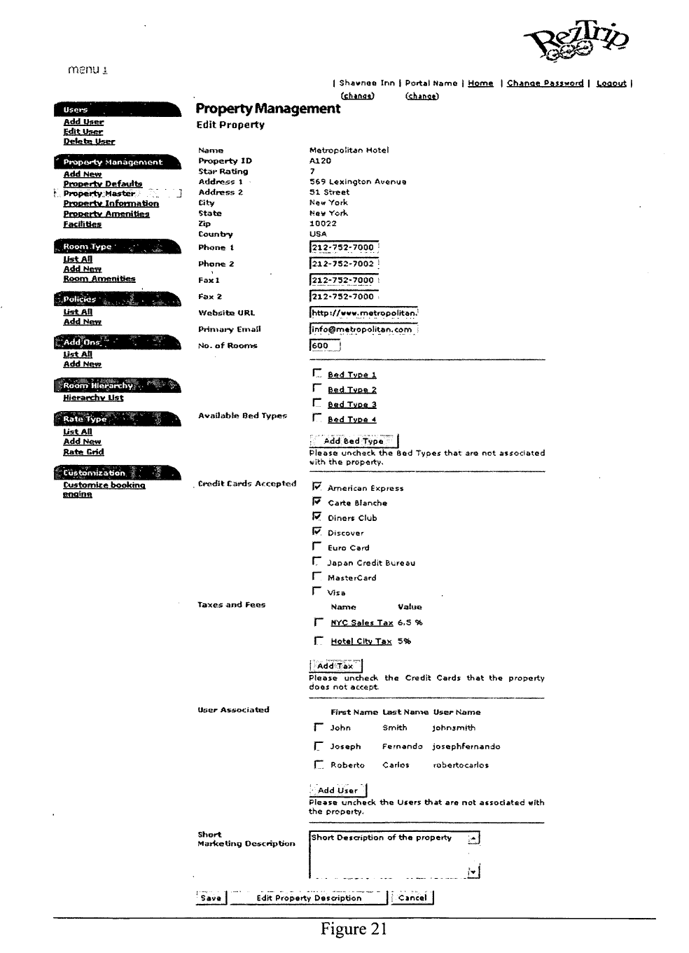

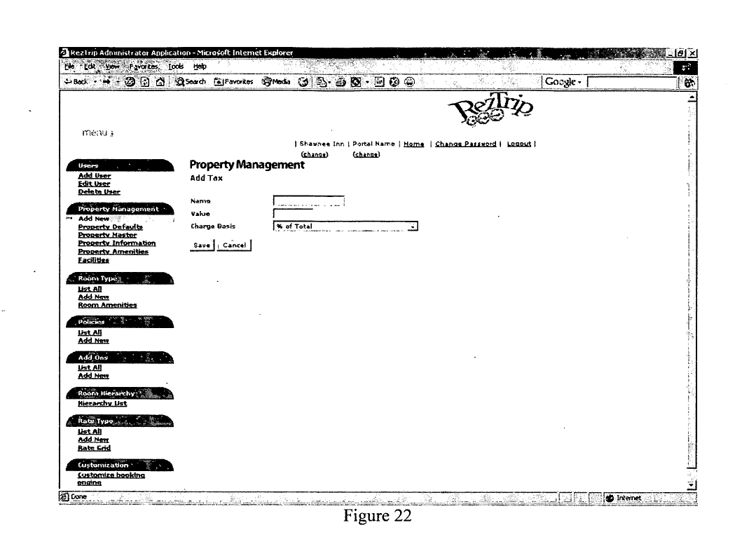

A Property is added to the system in a series of steps. First, the Property is created within the system. Second, the Property defaults are entered using the form shown in FIG. 19, and third, the Property master and other Property information attributes are entered using the form shown in FIG. 21. Finally, other information, such as descriptions, contact information, tax information, amenity information, facility information, and other information is added. Once a Property has been created the SU/EA either administers the Property themselves, or more likely, they create a new user with the role of PA, associate the new user with the Property, and then the new PA administers the Property. Alternatively an existing user with the role of PA could be associated with the Property. The PA has the day to day role of administering the Property, its Rooms, inventory, rates, and other data.

As shown in FIG. 17, the PA enters property data on the “Add Property”screen. The data comprise address information including street, city, state, country, postal code, as well as radio buttons indicating whether to display special rate types, default amenities, default property facilities, default bed types, and default common room attributes. After a Property has been added to the system it may be managed by selecting it from the Property list, as shown in FIG. 18. Selecting a Property from the Property list brings up a form displaying the default Property information as shown in FIG. 19. Default information comprises reservation transaction fee, active/inactive status, low inventory alert level, guarantee/cancellation policy, minimum room price, default currency, default date format, and check-in/check-out times.

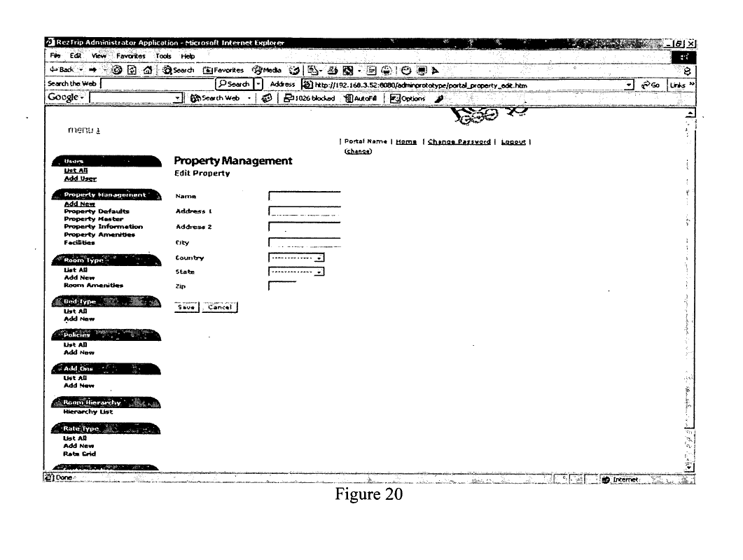

A Property may be selected for editing by using the “Edit Property” screen shown in FIG. 20. As shown in FIG. 21, editable attributes comprise the address, telephone and fax numbers, website address, email address, total number of rooms, bed types, credit cards accepted, taxes and fees, associated users (PAs), as well as a short description of the property. Tax information is set for the Property using the add tax form shown in FIG. 22. The taxes may comprise state taxes, city taxes, occupancy taxes, and other taxes and fees.

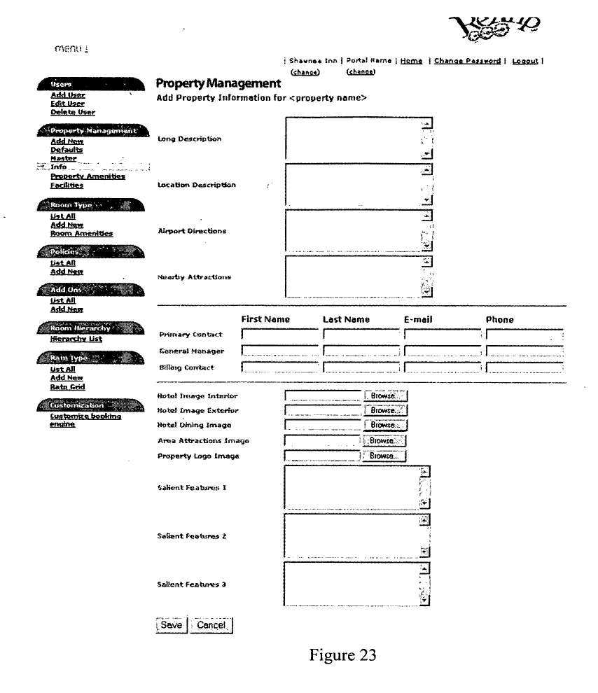

The Property information screen, shown in FIG. 23, is used to enter other Property data including contact information. Information comprising long description, location description, airport directions, nearby attractions, primary contact information, general manager contact information, billing contact information, interior and exterior images of the Property, Property logo, and other salient features of the Property are entered using this form.

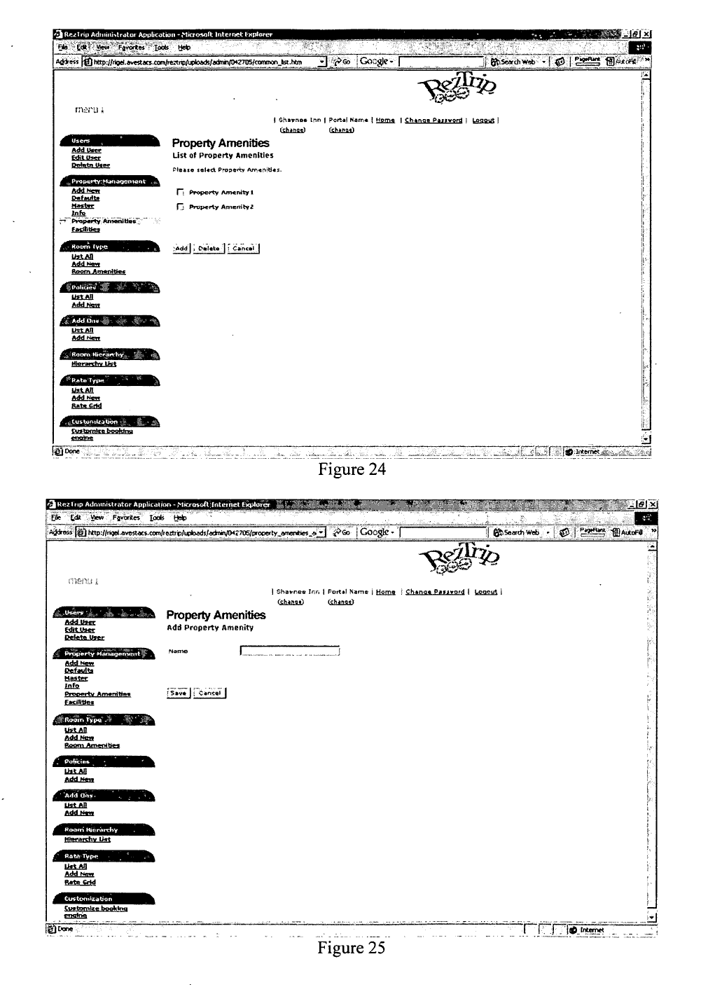

Property amenities, or amenity items, are managed using the forms shown in FIGS. 24 and 25 which are used to add, edit, and delete Property amenity items. Property amenities comprise such things as airport shuttle service, ATM/banking, audio/visual equipment, babysitting service, banquet service, business services (fax, email, copies), catering/event staff, children's activities, coin-operated laundry, high-speed internet access, concierge, conference center, cribs, currency exchange, daily newspaper, dry cleaning service, parking, luggage storage, massage room, safety deposit boxes, security, shoe shine, valet parking, and wake up calls. The system is configured to accept orders for items, including amenity items, in the reservation workflow.

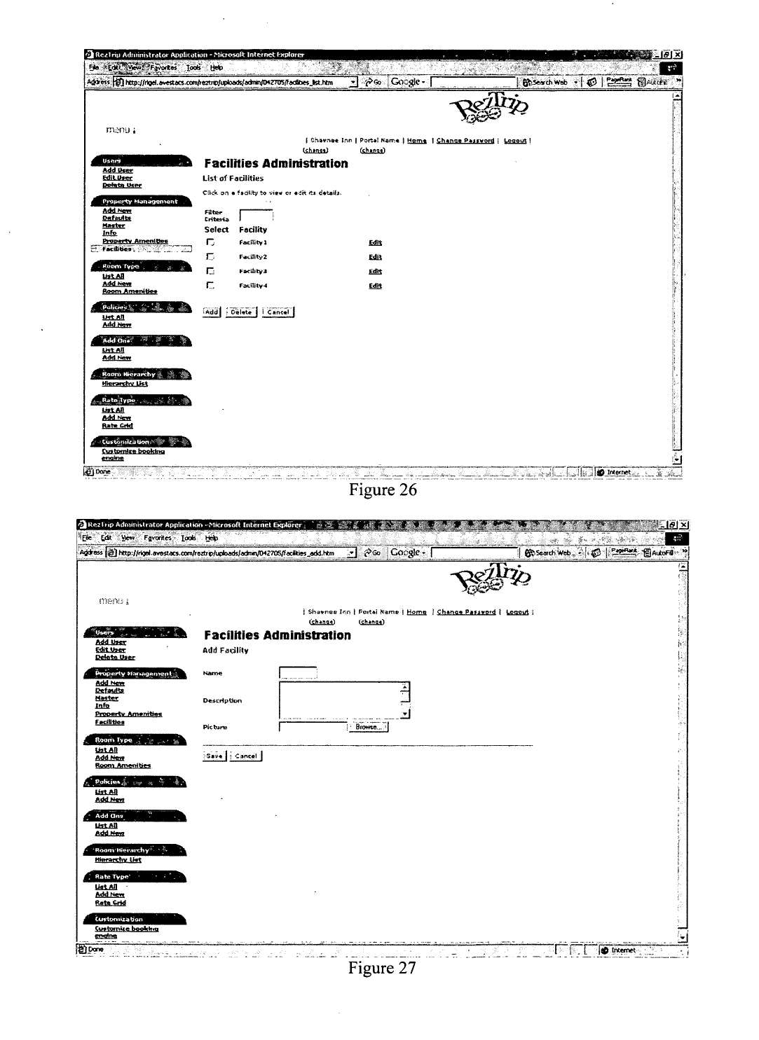

Property facilities, or facility items, are managed using the forms shown in FIGS. 26 and 27. The forms are used to add, edit, and delete Property facilities. Property facilities may include a bar, beauty salon, business center, coffee shop, fitness facility, spa, gift shop, lounge, restaurants, clubs, banquet rooms, swimming pool, casino, golf course, ski area, tennis courts, and other facilities available to customers. The system is configured to accept orders for items, including facility items, in the reservation workflow.

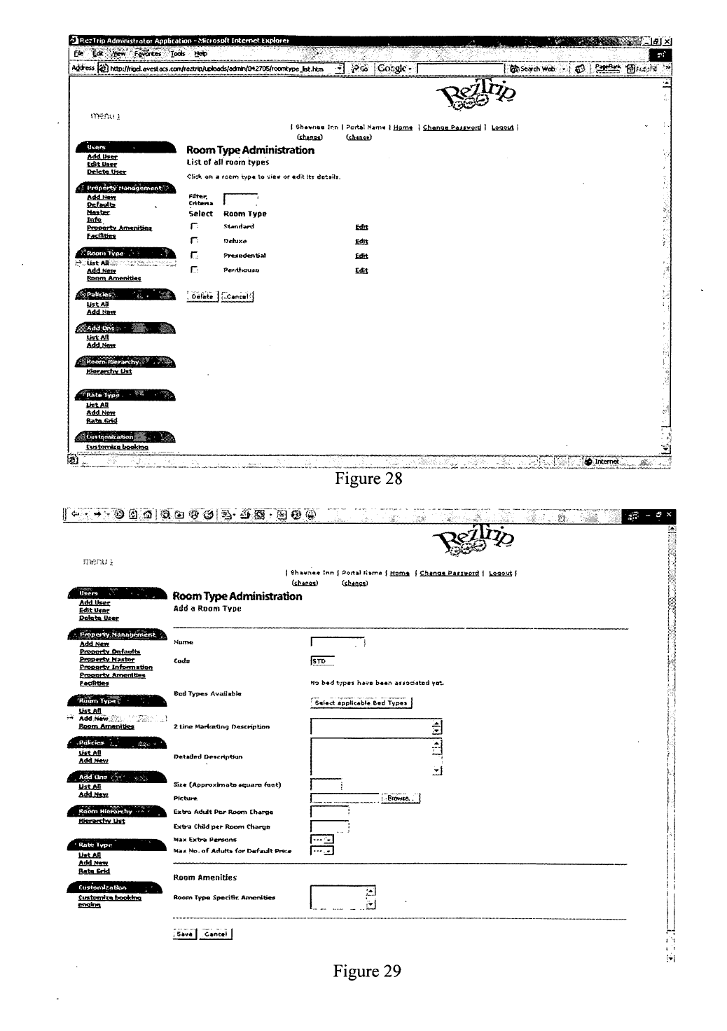

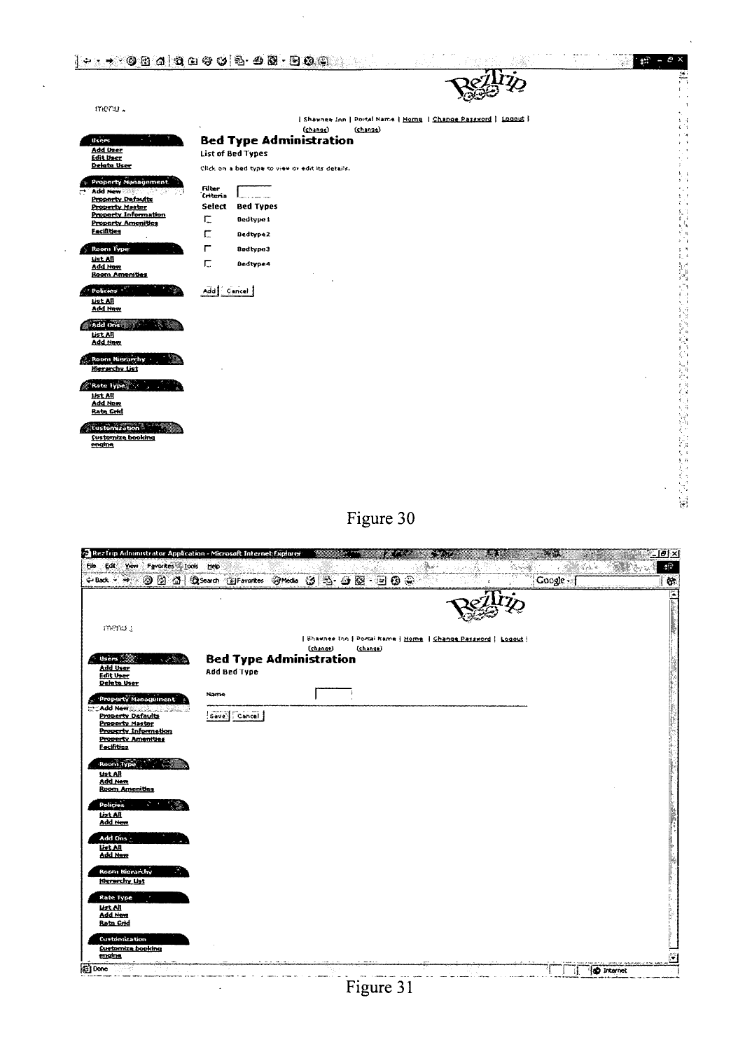

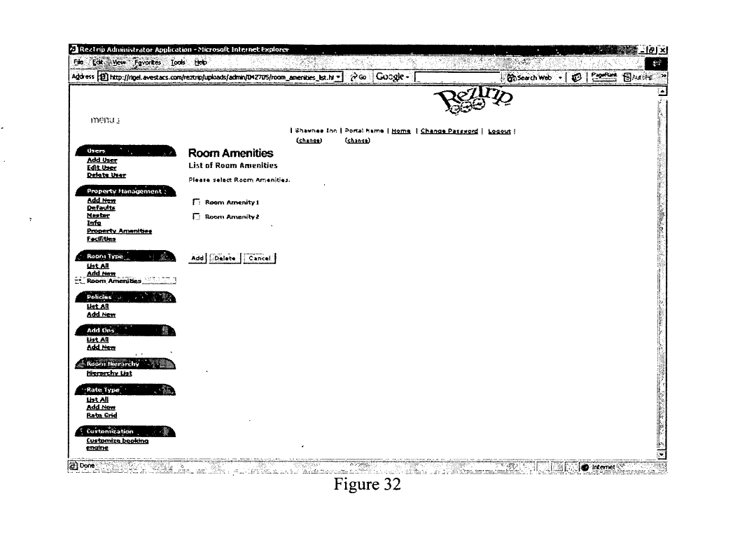

The Room Type code segment is configured to manage Room Type data and comprises Room Type functions. Once Properties have been created the PA needs to create at least one Room Type. Typically a plurality of Room Types are created. A Room Type creation form is shown in FIG. 29. PAs may “Add a New Room Type”, or “Delete a Room Type” as shown in FIGS. 28 and 29. PA's may also enter room type data, and edit room types. PAs can manage bed types using the forms shown in FIGS. 30 and 31, as well as room amenities using the form shown in FIG. 32. Any Property may have at least one or more room types comprising, for example, standard, deluxe, presidential, penthouse, and suite. On a given date, a Room can be sold at multiple rates based on the Rate Type or types that are applicable to the Room and the customer. The rates for each of the Room Types may be modified by:
Discounts based on a code provided such as AAA™, Senior Citizen, Government.
Flat rates for organizations that have signed an agreement with the Property, such as a corporation.
Promotional discounts from direct mail, website, or email campaigns

Other discounts or promotions may also apply. Therefore a Room Type may have multiple rates at which it can be sold on a given day.

Each Room Type within the system will be entered with a default selling rate along with the inventory for each calendar date. However, the same rate may not be offered to everyone. In certain instances a discount may be offered to a group of EUs. Therefore, the code segment provides functionality to associate various Rate Types with each Room Type for a given date. For example, the rate for a standard room across a series of dates could be as follows:

| | Standard Room- | | |
|---|---|---|---|
| Rate Type | 04/11/05 | 04/12/05 | 04/13/05 |
| Default Rate | $139 | $159 | $199 |
| AAA ™ Rate | $126 | $144 | $180 |
| Government Rate | $130 | $150 | $190 |
| Summer Package Rate | $100 | $100 | $100 |

For a deluxe room, the matrix could look like:

| | Deluxe Room- | | |
|---|---|---|---|
| Rate Type | 04/11/05 | 04/12/05 | 04/13/05 |
| Default Rate | $159 | $179 | $219 |
| AAA ™ Rate | $144 | $162 | $198 |
| Government Rate | $150 | $150 | $150 |
| Summer Package Rate | NA | NA | NA |

NA—Not Available

The Room Type and room rate that is shown to an EU using the reservation engine is based upon a rate grid that is maintained by the PA.

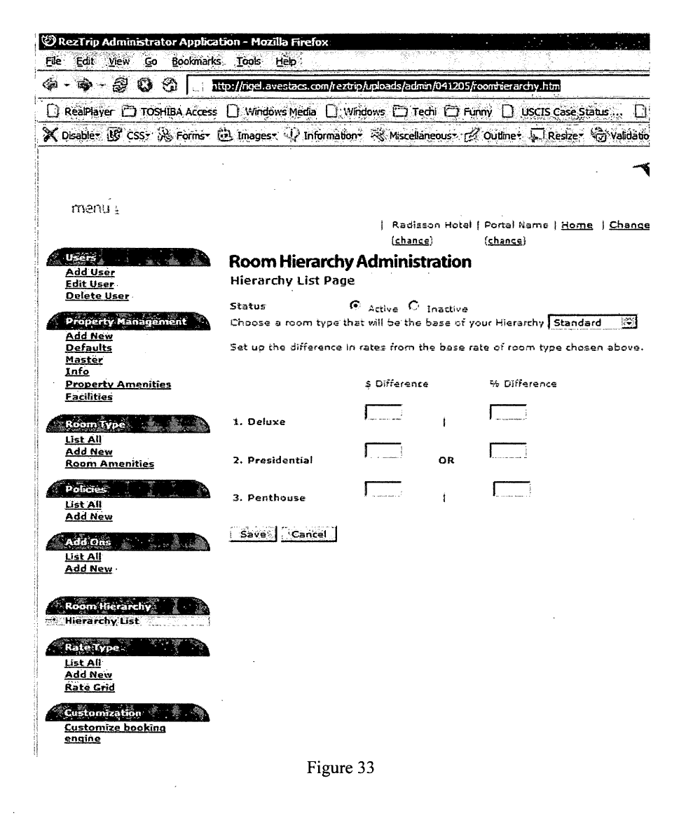

The Room Type Hierarchy code segment is configured to manage Room.Type Hierarchy data. The application allows the PAs to enter Room Type hierarchy data using the form shown in FIG. 33. PAs may enter the Room Types in a hierarchy and then define rates that are higher or lower than the standard room rate (BAR) by defined dollar amounts or by defined percentages or by a mathematical formula, simplifying the management of rate data.. If new Room Types are added to the Property, they may also be added to the hierarchy. In addition, the Room Type hierarchy may be used with Non-Floating Rates (stand alone with/without inventory). Floating rates are created and used as follows:
Identify a standard Room Type.
Enter a BAR Rate for the standard room type.
Identify associated Room Types.
Enter price difference data relating the standard room type to associated room types. The price differences may be calculated, by the system, using percentages, defined dollar amounts, or mathematical formulas.
Calculate the prices for associated Room Types based upon the BAR rate and the price differences. The code segment may be configured to perform calculations automatically and/or perform calculations in response to a user initiated triggering event, such as a mouse click.
Automatically recalculate prices for associated Room Types in response to changes in the BAR rate. The code segment may be configured to perform calculations automatically and/or perform calculations in response to a user initiated triggering event, such as a mouse click.
Communicate the prices to a plurality of sales channels. The code segment may be configured to automatically communicate the prices and/or communicate in response to a user initiated triggering event, such as a mouse click.

A floating rate relies on the fact that, typically, the price of a Room Type varies across the Rate Types by a fixed amount or fixed percentage. The rates can be defined as a positive or negative difference from the standard Room Type and the differences may be defined in numeric (dollar) terms or in percentage terms or in terms of a mathematical formula. Once the rate has been set for a Room Type/Rate Type/Date the value will propagate to all rooms of that type on that date.

Each slot in the rate grid (Room Type/Rate Type/day combination) will by default derive its rate using the Room Type hierarchy and/or the Rate Type hierarchy. However, the PA is allowed to manually override the calculated prices by entering specific values. For example, there may be exceptions on days considered “Hot Days” such as holidays or local event days and the rates for those days may be overridden. Typically, exception days account for about 10% of days. Overriding a room rate for at least one room on a given date will not override the rate for the rest of the rooms of that Room Type. Rate Types which are not dependent upon the BAR rate will not be affected by Room Type hierarchy. The PA manages the values for all Room Types associated with Rate Types using the rate grid.

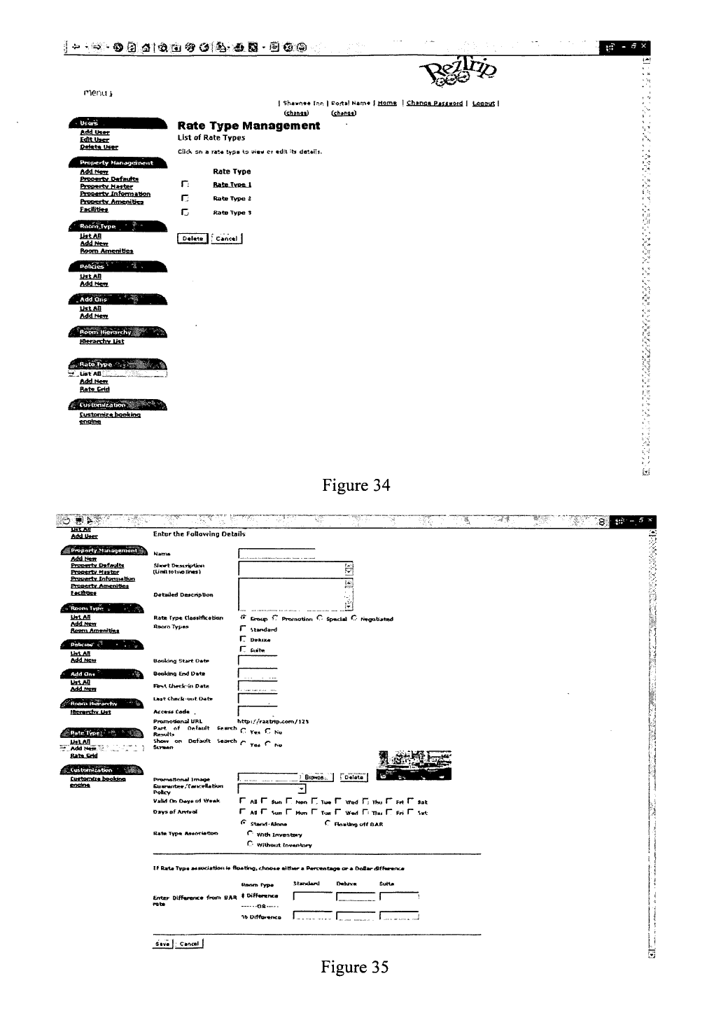

The rate type code segment is configured to manage rate type data and comprises rate type functions. Embodiments of the invention allow PAs to create and edit Rate Type definitions. The Rate Type code segment comprises subsegments for Rate Type creation and maintenance as well as rate grid maintenance. The rate list form shown in FIG. 34 may be used to list all current rates and to select them for editing or removal. The Rate Type editing form shown in FIG. 35 is used to enter Rate Type data or to edit existing Rate Types. Rate Type information comprises name, short description, detailed description, classification, effective dates, guarantee/cancellation policy, and whether the rate is floating off the BAR or is a non-floating rate.

The following method may be used for setting up Rate Types:
Assign a default Rate Type to each Room Type prior to sales through the system.
Assign Additional Rate Types to Room Types by associating the additional Rate Types with the default Rate Type in one of the following ways:
   A percentage difference from the default Rate Type.
   A dollar difference from the default Rate Type.
   A mathematical formula comprising the default Rate Type.
   An absolute value with no relation to the default Rate Type. (non-floating rate)

A Rate Type may be set for all or only a portion of the available Room Types. The Rate Types that a PA may create and enter comprise the following categories:
BAR Rate
Promotion rates
Promotion rates with inventory
Group rates
Negotiated Rates
Special Rates

When a Property is initially created a default Rate Type will be created. This Rate Type is referred to as the BAR rate. The BAR rate is be created, entered, and associated with rooms prior to sales through the reservations engine. The Property may choose to rename the BAR rate. If the BAR rate is renamed the application uses the new name on all forms. The BAR rate type cannot be deleted. A property cannot sell a Room Type under any floating Rate Type on any day unless the BAR rate has been set up for that day. The SU/EA/PA cannot create another BAR rate or modify other rate types to become the BAR rate. The BAR rate serves as the basis of the floating Rate Types. Upon creation of a Room Type it will be immediately available under the BAR rate. The Room Type does not have to be explicitly associated to the BAR rate, unlike other Rate Types which must be explicitly associated with Room Types.

The Promotion Rate is a Rate Type a Property might create and offer for sale to improve the revenue stream of the property. These Rate Types can be set up with restrictions, for example, minimum length of stay and valid only on certain days of week. The promotion Rate Type can be set up to be available permanently or within a specific time frame. The Rate Type can use absolute dollar amounts for room prices or the prices can be floating based upon the BAR rate. This Rate Type will use the inventory that is associated with the BAR. Therefore, if the BAR for standard rooms has 100 rooms, and if 20 rooms are sold at BAR rate, then 80 rooms remain available to be sold at the BAR rate and at any of the promotional rates that are available for the dates.

The Promotion Rate with inventory allows the Property to sell only a portion of the rooms at the promotional rate. In this case the promotional Rate Type will have its own inventory. If for example, a “Winter Promotion Rate Type” is given an inventory of 20 rooms for the dates December 1 through December 20, any room sold with this Rate Type will not affect the BAR inventory and vice versa.

A Group Rate may be given to a group that agrees to book a minimum number of rooms. A Property does its bookings through various channels, and it associates inventory with various Rate Types in order to maximize occupancy rate and maximize room rate for each Room Type. Typically, not all rooms are sold through individual sales, therefore the property will sell some of its rooms to groups who guarantee to book rooms for a set of dates. These Rate Types are typically given their own inventory and do not use the BAR inventory.

Corporate Rates are often negotiated with corporations whose employees regularly stay at the Property. A Property may have a relationship with airlines and other large companies to offer their employees a discounted rate. The corporate Rate Type may use the BAR inventory.

Government Rates are Rate Types that are offered to government employees. Typically the government Rate Type uses the BAR inventory.

Senior Citizen Rates may be offered to all visitors who meet or exceed the Property's defined senior citizen age. The PA must specify the minimum age required for this Rate Type, in the rate description. This Rate Type may use the BAR inventory.

AAA® Rates are the rates offered to members of AAA® and its affiliate organizations. A description of the affiliate organizations must be provided by the PA in the description for this Rate Type. This Rate Type may use the BAR inventory.

A rate cluster is a logical grouping of the Rate Types for the purpose of opening or closing the Rate Types from the rate grid. Rate clusters will allow the PA's to open/close Rate Types as a cluster from the grid. A Rate Type can only belong to one rate cluster.

Over time a Property can introduce and maintain a number of Rate Types. These Rate Types will typically be managed by one or two persons per property. One of the key activities to be performed with a Rate Type is to either make it available for sale or to take it off the grid. Taking a Rate Type off the grid does not mean that it needs to be removed altogether from the database, since the Rate Type might be used in the future.

The rate grid code segment is configured to manage rate grid data and comprises rate grid functions. Once the Rate Types are created the groundwork for selling rooms is complete. However, the actual room prices are not yet available to EU's. Embodiments of the invention use rate grid forms to enable the administrator to control the prices and other attributes that are associated with the rooms.

The rate grid is used to define the price of a specific Room Type, for a Rate Type, on particular days, optionally subject to other constraints. The rate grid can be viewed as a three dimensional matrix where each cell in the matrix contains reservation related attributes. The dimensions of the matrix comprise:
Room Type
Rate Type
Date

Each cell (also referred to as a rate grid entry) in this matrix contains information comprising:
Price
Inventory
Minimum length of stay
Open / closed status
Cut off days (only if inventory is present)

To determine if a standard room is available for sale on a particular day for a 2 night stay, the rate grid is checked to see if the appropriate cell exists in the rate grid. If the cell exists, the values in that cell are used to calculate the price of the standard room. The cell in the rate grid matrix is referred to as a rate grid entry. If the rate grid entry is not present on a given day for a Rate Type or Room Type then that Rate Type or Room Type must be treated as unavailable for sale on that day.

A typical lifecycle of a rate can be described by the following:
The PA creates/edits a Rate Type weeks or months before the first check-in date.
The PA enters the rates for the dates between the check-in and the check-out dates (the Rate Type active period). Alternatively, the system creates the rate grid entries for floating rates when the Rate Type is created.
The PA monitors room inventory levels for the days in the Rate Type active period to identify the days that might be selling out soonest. If a day within the Rate Type active period is selling more quickly than other days in the period, the PA may adjust the price for rooms offered on that date. The PA may adjust prices in response to date changes, for example the price of an unreserved room may be lowered as the reservation date approaches. Selling the room for something is preferable to allowing the room to remain vacant. The PA uses the system to quickly change rates:
   Across specific days of the week (Mondays, weekends).
   On selected dates.
   Across specific Rate Types.
If a sales channel's Room Type inventory is sold out or is selling better than other channels, the PA might choose to reallocate inventory to the better-selling channel. Alternatively, the PA may choose to close the Rate Type/Room Type, for a given date or a series of dates, for certain channels.
Eventually the last check-out date is passed or the check-in date cut-off day is reached and the Rate Type is no longer available for a given room. The PA now has the option to:
   Let the Rate Type remain in the db.
   Modify the last check out date to extend the active period for the Rate Type.
   Delete the Rate Type from the system.

The rate management process may be repeated on a regular schedule, such as twice daily, daily, twice weekly or weekly depending upon the needs of the Property. Frequent updating and communication of pricing and inventory information to the sales channels keeps the information fresh at the sales channels.

Embodiments of the invention may use Rate Type management forms and rate grid forms to provide the functions necessary to perform the steps covered above. The rate grid forms are designed to handle the floating rates that are created via the Rate Type management screens.

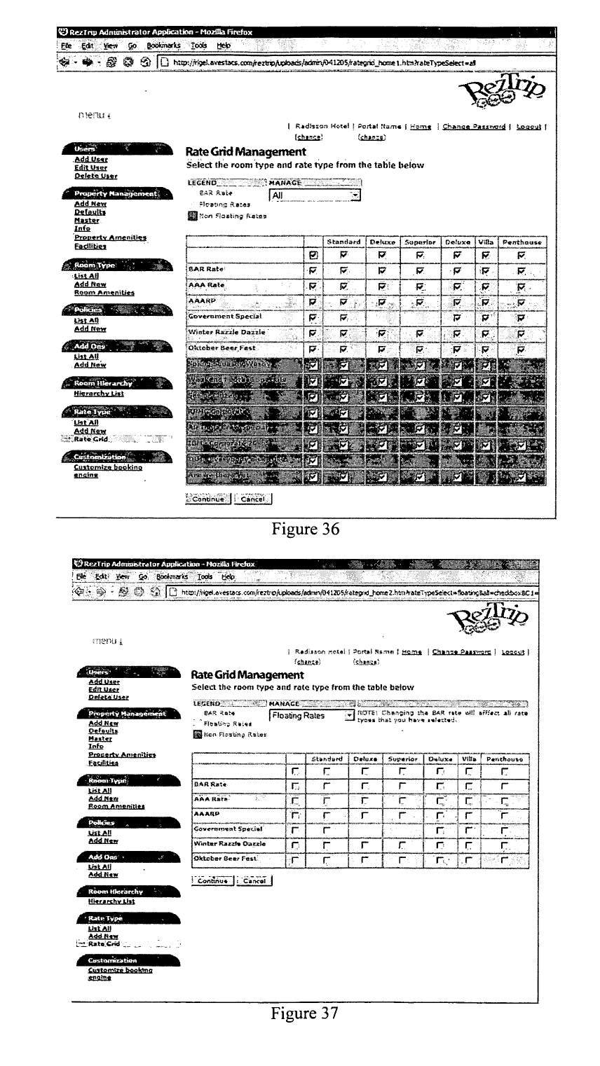

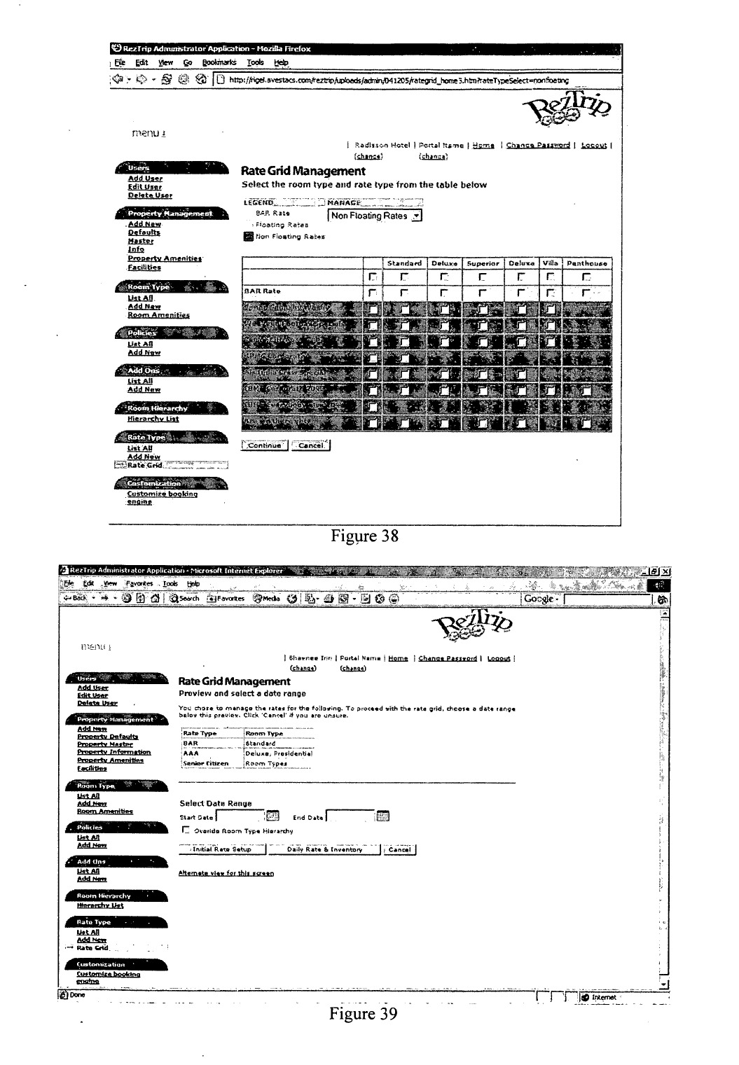

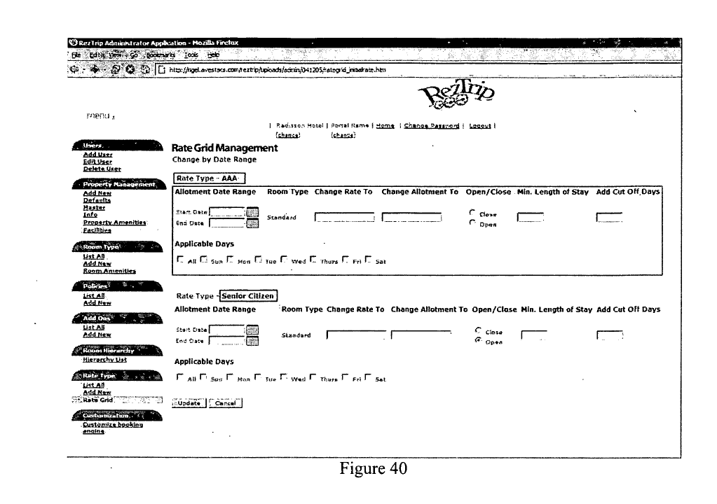

The rate grid code segment comprises the following forms:
Rate Type and Room Type selection form. This form allows the administrator to choose the Rate Types and the Room Types that they wish to manage. FIG. 36 shows a selection form where all Rate Types and all Room Types have been selected via the drop down menu. FIG. 37 shows a form where only floating Rate Types have been selected and FIG. 38 shows a form where only non-floating Rate Types have been selected.
Date range selection form. This form allows administrators to enter the date data specifying the time periods over which they wish to make changes. FIG. 39 shows an example of the date range selection form. The Rate Types BAR, AAA, and Senior Citizen are selected for management. The next form is shown in FIG. 40. Here the AAA™ and Senior citizen rates, as selected on the previous form, are being managed. Information comprising effective dates, days of the week, rate, inventory allotment, minimum length of stay and cut off days may be entered.

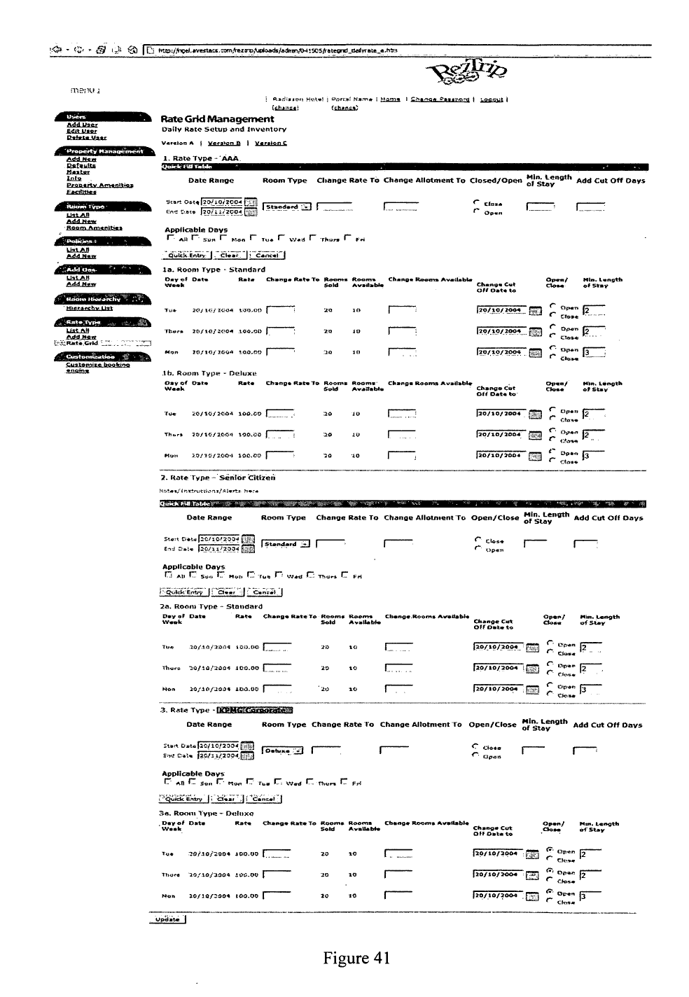

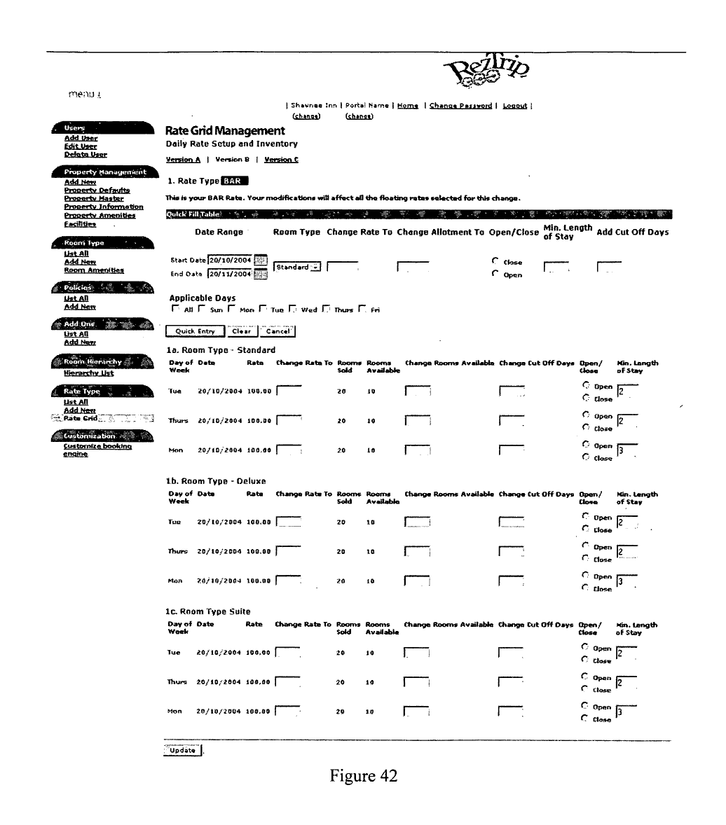

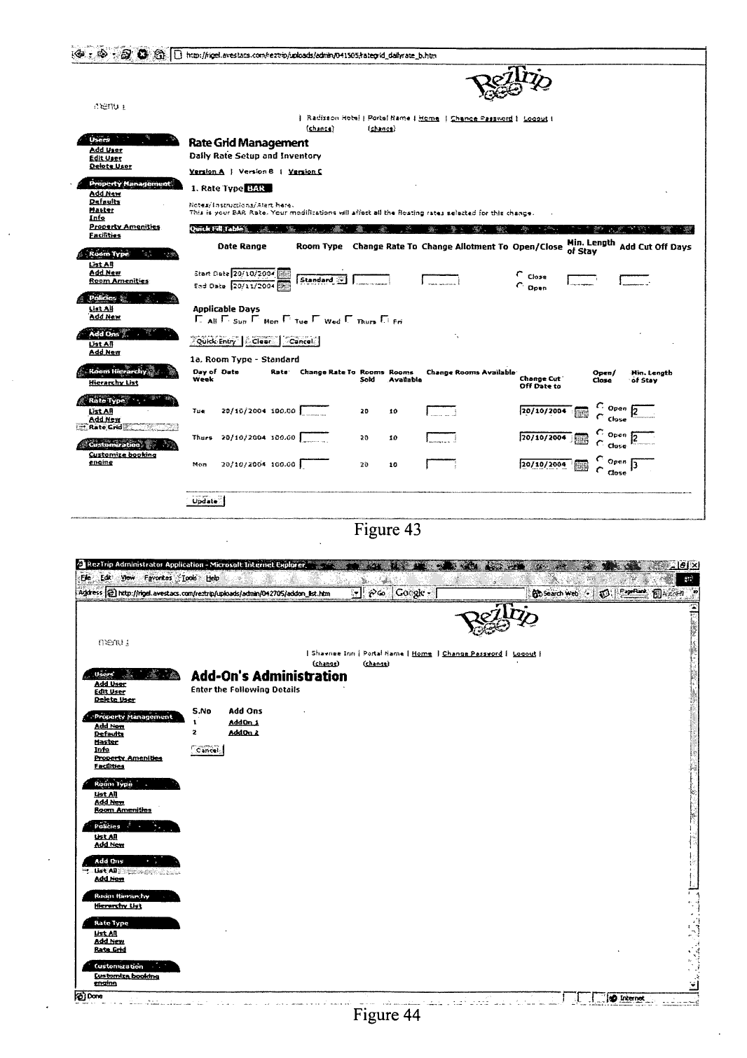

Daily rate and inventory forms are used to manage prices and inventory on a daily basis. As shown in FIGS. 41-43 the daily rate and inventory form allows the PA to manage information comprising date ranges, Rate Types, Room Types, days of the week, inventory allotment, minimum length of stay and cut off days.

The communications code segment is configured to communicate with at least one sales channel, and/or a plurality of sales channels and comprises communications functions. Once the Rate Types, Room Types, and inventory have been managed through the rate grid mechanism the pricing information, inventory information, and other information is communicated to the selling channels. Other information communicated to the selling channels may comprise add-on information, package information, amenity information, and facility information. The information is communicated to the selling channels in response to a triggering event. A triggering event may initiated automatically by the system upon completion of a pricing update, or a triggering event may be initiated by the PA, for example by a mouse click. As shown in FIG. 4, the RezTrip™ system may be connected to a plurality of selling channels comprising the hotel reservation desk, the hotel website, other websites, GDS systems, tour operators, travel agents, computerized reservation providers, telephone reservation service providers and others. The updated pricing and availability inf6rmation may be sent to the selling channels electronically over wired or wireless networks, such as the internet or telephone systems, or with facsimile transmission. The information may be communicated in encrypted or unencrypted form.

The reservation engine code segment is configured to manage reservation engine data and comprises reservation engine functions. When an EU, using the reservation engine, successfully completes a reservation, a confirmation is sent to the EU. The application also notifies the PA to allow the administrator to perform the associated financial and administrative tasks. The application sends confirmations to the EUs and notifications to the PA via communications over wired or wireless networks in either an encrypted or unencrypted form. Typically, the communications will comprise an electronic mail message or a facsimile message.

The audit trail code segment is configured to manage audit trail data and comprises audit trail functions. The rate changes to a Room Type for a specific Rate Type can be performed by any of the SUs, EAs or PAs associated with the Property. Therefore, the application has a code segment which tracks changes, providing an audit trail. Each audit trail entry comprises the following information:
1. Changes to Rates
   a. Property
   b. Room Type
   c. Rate Type
   d. Timestamp of change
   e. Original Rate
   f. Changed Rate
   g. Logged in usemame
2. Changes to Inventory
   a. Property
   b. Room Type
   c. Rate Type
   d. Timestamp of change
   e. Original Inventory
   f. New Inventory
   g. Logged in usemame
3. Change in Stay restrictions
   a. Property
   b. Room Type
   c. Rate Type
   d. Timestamp of change
   e. Type of restriction change (e.g. Open/Close, Minimum Length of stay etc.)
   f. Original value
   g. New Value
   h. Logged in username

The add-on code segment is configured to manage add-on data and comprises add-on functions. Embodiments of the invention provide a way for the PA to define add-ons for the Property so that they may be offered in the reservation workflow. An add-on is defined as any additional service/feature/amenity/item that is available through the Property and can be sold to EUs during the course of making a reservation. The add-on items must be defined by the PA's and must be created with relevant details, so that the details can be shown during reservation workflow. Examples of add-on items include:

Parking: parking could be sold for an additional $20 per night with each Room Type. Add-on pricing may use various multipliers. Based on the multipliers, the total amount will be calculated. The multipliers could be:

| Multiplier | Details |
|---|---|
| Per stay | The charge would be added to the reservation and is not |
| | dependent on the number of travelers. It is multiplied by |
| | the number of rooms in the reservation. For example, |
| | high-speed internet priced at $50 If 3 rooms were booked |
| | the total charge would be $150. |
| Per occupant | The charge would be per occupant for the duration of the |
| per stay | stay. It does not depend on the number of nights. For |
| | example, airport pickup, $8 per person. |
| Per night | This is a charge per room per night. For example, parking, |
| | $24 per night. |
| Per occupant | For example, breakfast at $12. For 3 persons for a 3 night |
| per night | stay, the total charge would be $108 (12 × 3 × 3). |

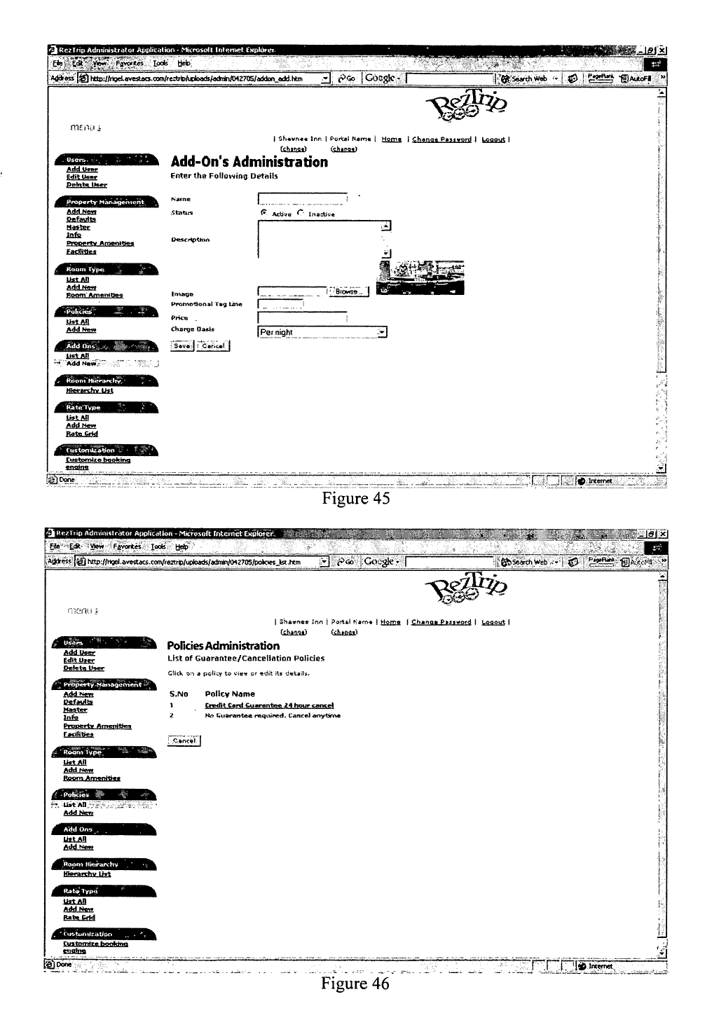

Add-on item management forms are shown in FIGS. 44 and 45. The add-on management forms allow the PA to create, edit, and activate/inactivate add-on items. The system is configured to accept orders for items, including add-on items, in the reservation workflow.

Because the end users may pick and choose add-on items during the reservation workflow, the system allows EU's to dynamically create their own add-on item deals. Pricing is automatically calculated based upon factors comprising the price of the add-on item and the associated per-person and/or per-night multiplier. For example, if an EU books a reservation for two persons, including continental breakfast, for three days, then a fee of six times (two persons by three days) the continental breakfast fee will be added to the reservation total. If the EU, then changes the booking and only reserves for a single person the continental breakfast fee total will be automatically changed to a value of three times the continental breakfast fee.

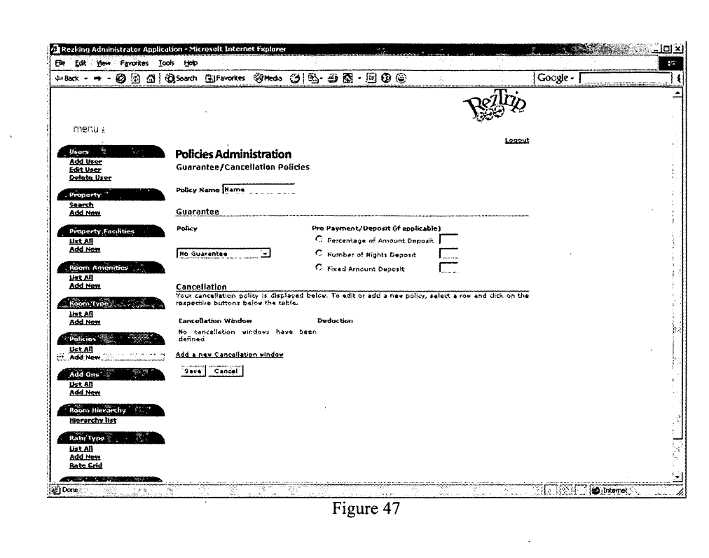

Policies of the Property may be managed with the policy forms shown in FIGS. 46 and 47. Policies may comprise cancellation policies, credit card acceptance policies, and room guarantee policies.

The package creation code segment is configured to manage package creation data and package creation functions. Embodiments of the invention provide a way for the PA to create packages/specials/items that can be offered to EUs during the reservation workflow. For example, a Property may have discounted rates. These discounted rates are usually offered during low booking seasons to maintain occupancy levels. The following types of promotions are configurable by the embodiments of the invention:
Fixed Rate Promotions: $ per night for a specific room type for a given set of dates
Floating Value Promotions: These can be of three types
   A percentage off the rate for that Room Type
   A dollar amount off the rate for that Room Type

A package or special may comprise one of the following constraints:
Minimum number of nights to stay.
Maximum length of stay, for example must not exceed four nights.
Valid on specific days of the week, for example, Monday and Tuesday only.
Valid within a specific set of dates.
Day of Arrival, for example, check-in date must be Monday.
Day of Departure, for example, check-out date must be Wednesday.

The system is configured to accept orders for items, including package items, in the reservation workflow. As the EU selects the package items the total fee for the package items is automatically calculated based upon factors comprising the package items selected, the length of the stay, and the number of persons taking advantage of the package items. If the EU changes the package items the total fee is automatically recalculated based upon factors comprising the package items selected, length of stay, and number of persons taking advantage of the package items.

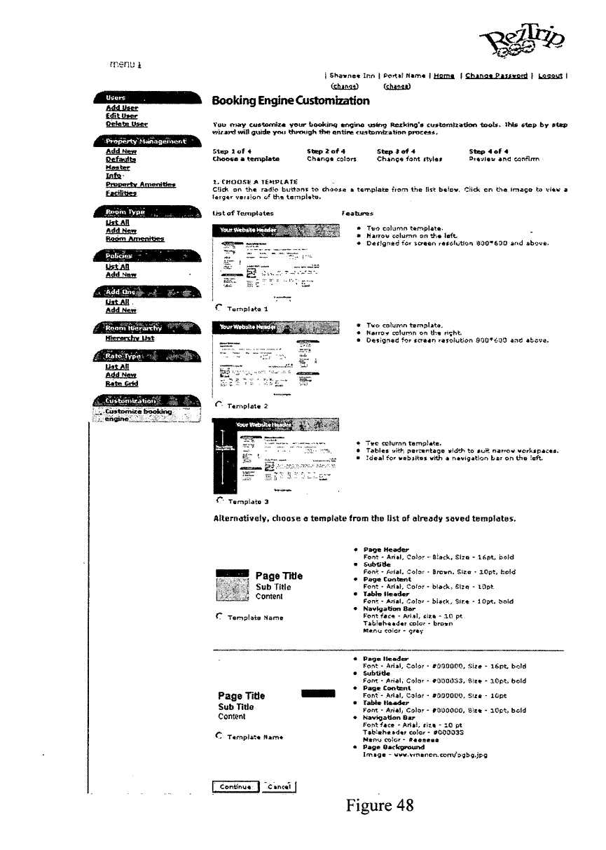

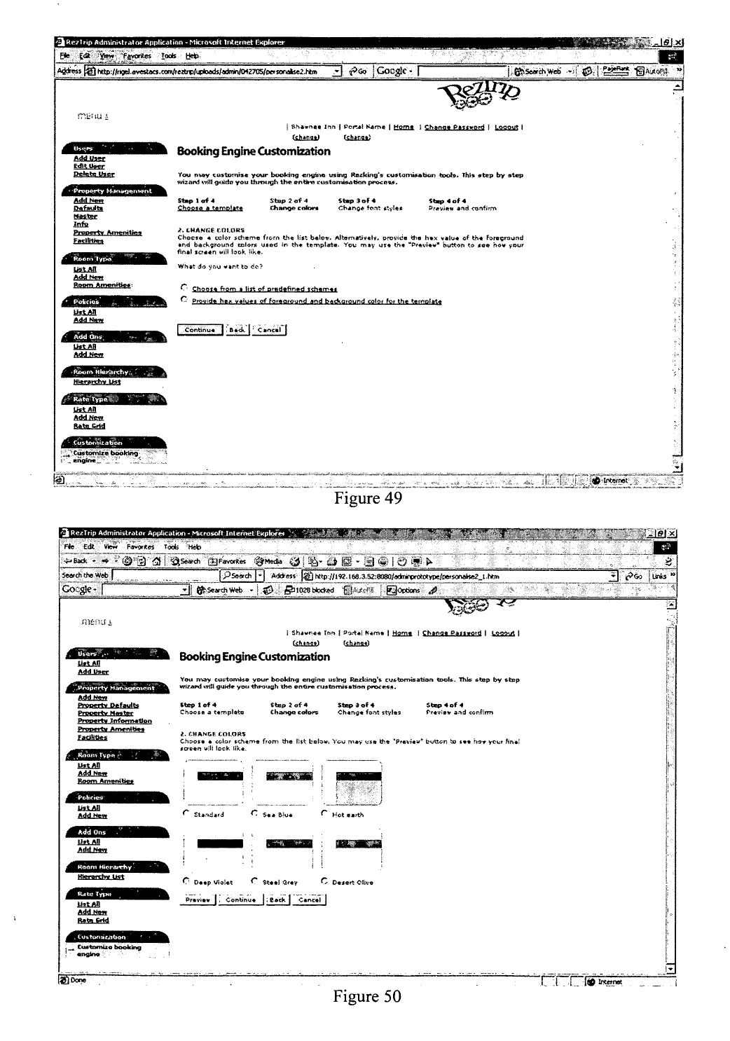

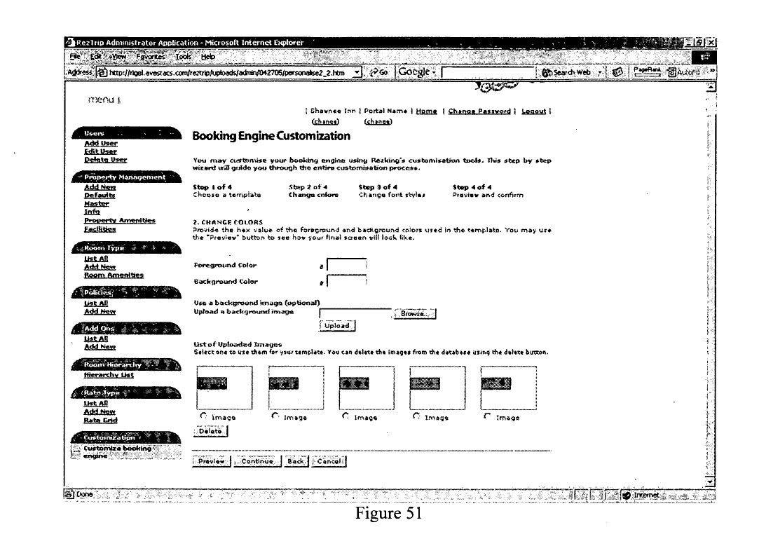

The engine customization code segment is configured to manage engine customization data. Embodiments of the invention comprise a code segment that allows customization of the appearance of the reservation engine. As shown in FIGS. 48-51, the customization process may comprise the steps of selecting a template, choosing a color scheme, choosing a font style, and confirming the choices made. The customization code segment allows each Property to modify the appearance of the reservation to conform to the image of the Property.

I claim:

1. A hotel pricing and inventory management system comprising:
a database configured to manage hotel data;
a code segment configured to manage user interaction;
a code segment configured to manage portal data;
a code segment configured to manage property data;
a code segment configured to manage room type data;
a code segment configured to manage room hierarchy data;
a code segment configured to manage rate type data;
a code segment configured to manage rate grid data;
a code segment configured to communicate with a plurality of selling channels.

2. The system of claim 1 further comprising a code segment configured to accept reservations.

3. The system of claim 2 further comprising a code segment configured to accept orders for items.

4. The system of claim 1 further comprising a code segment configured to manage an audit trail.

5. The system of claim 1 further comprising a code segment configured to communicate pricing information and inventory information to a plurality of sales channels.

6. The system of claim 5 further comprising a code segment to automatically communicate pricing information and inventory information to a plurality of selling channels in response to a triggering event.

7. A computer readable medium comprising a hotel pricing and inventory management system further comprising:
a database configured to manage hotel data;
a code segment configured to manage user interaction;
a code segment configured to manage portal data;
a code segment configured to manage property data;
a code segment configured to manage room type data;
a code segment configured to manage room hierarchy data;
a code segment configured to manage rate type data;
a code segment configured to manage rate grid data;
a code segment configured to communicate with a plurality of selling channels.

8. The computer readable of claim one further comprising a code segment configured to accept reservations.

9. The computer readable medium of claim 8 further comprising a code segment configured to accept orders for items.

10. The computer readable medium of claim 7 further comprising a code segment configured to manage an audit trail.

11. The computer readable medium of claim 7 further comprising a code segment configured to communicate pricing information and inventory information to a plurality of sales channels.

12. The computer readable medium of claim 11 further comprising a code segment to automatically communicate pricing information and inventory information to a plurality of sales channels in response to a triggering event.

13. A method of managing hotel pricing and inventory information comprising:
providing a database configured to manage hotel data;
providing a first code segment configured to manage hotel data;
providing a second code segment configured to manage user interaction;
interacting with the code segments by:
(a) entering portal data;
(b) entering property data;
(c) entering room type data;
(d) entering room hierarchy data;
(e) entering rate type data;
(f) entering date data;
(g) communicating pricing and inventory information to a plurality of sales channels.
(h) monitoring room inventory;
(i) adjusting prices in response to changes in room inventory;
(j) adjusting prices in response to date changes;
(k) communicating pricing and inventory information to a plurality of sales channels;
(l) repeating steps (i) through (l) on a regular schedule.

14. The method of claim 13 further comprising the step of entering amenity item data.

15. The method of claim 13 further comprising the step of entering add-on item data.

16. The method of claim 13 further comprising the step of entering package item data.

17. The method of claim 13 further comprising the step of accepting reservations.

18. The method of claim 13 further comprising the step of accepting orders for items.

19. The method of claim 13 further comprising the step of automatically communicating pricing information and inventory information to a plurality of sales channels in response to a triggering event.

20. A method of managing hotel room pricing comprising the steps of:
identifying a standard room type;
entering a BAR rate for the standard room type;
identifying associated room types;
entering price difference data relating the standard room type to associated room types;
and calculating prices for associated room types based upon the BAR rate and price difference data.

21. The method of claim 20 further comprising the steps of:
assigning a default rate type to each room type;
and assigning additional rate types to room types.

22. The method of claim 21 further comprising the steps of:
changing the BAR rate for the standard room type;
automatically recalculating prices for associated room types based upon the changed BAR rate and price difference data.

23. The method of claim 21 further comprising the step of manually overriding the calculated price of at least one room.

24. The method of claim 21 further comprising the step of communicating pricing information and inventory information to a plurality of sales channels.

25. The method of claim 21 further comprising the step of automatically communicating pricing information and inventory information to a plurality of sales channels in response to a triggering event.

26. A system for managing hotel room pricing comprising:
a code segment configured to manage a standard room type;
a code segment configured to manage a BAR rate for a standard room type;
a code segment configured to manage associated room types;
a code segment configured to manage price difference data relating the standard room type to associated room types;
a code segment configured to calculate prices for associated room types based upon the BAR rate and price difference data.

27. The system of claim 26 further comprising:
a code segment configured to manage rate type data;
and a code segment for associating rate type data with each room type.

28. The system of claim 27 further comprising a code segment for automatically recalculating prices in response to a change in the BAR rate.

29. The system of claim 27 further comprising a code segment configured to manage manually overriding prices.

30. The system of claim 27 further comprising a code segment configured to communicate pricing information and inventory information to a plurality of sales channels.

31. The system of claim 27 further comprising a code segment configured to communicate pricing information and inventory information to a plurality of sales channels in response to a triggering event.
